(19) United States
(12) Patent Application Publication
(10) Pub. No.: US 2026/0194646 A1
(43) Pub. Date: Jul. 9, 2026

(54) METHOD FOR CALCULATING A TRAJECTORY OF AN OBJECT, SYSTEM, COMPUTER PROGRAM AND COMPUTER-READABLE STORAGE MEDIUM

(71) Applicant: ams-OSRAM AG, Premstätten (AT)

(72) Inventors: Pierre HILLERITEAU, Anglet (FR); Josselin MANCEAU, Bagneux (FR); Yannick MENET, Chatillon (FR); Di AI, Créteil (FR); Matthew SAMPSELL, Melissa, TX (US); Pradeep HEGDE, Frisco, TX (US); Peter TRATTLER, Seiersberg-Pirka (AT)

(21) Appl. No.: 19/132,919

(22) PCT Filed: Nov. 27, 2023
(86) PCT No.: PCT/EP2023/083185

§ 371 Date: May 27, 2025

Related U.S. Application Data
(60) Provisional application No. 63/428,305, filed on Nov. 28, 2022.

(51) Int. Cl. G01S 13/58; G01S 13/86; G06T 7/20; G06V 40/20

(52) U.S. Cl. CPC G01S 13/58; G01S 13/867; G06T 7/20; G06V 40/28

(57) ABSTRACT

A method for calculating a trajectory of an object with a low resolution time of flight sensor with pixels arranged in lateral directions next to one another includes providing measurement values of the pixels for different time frames. The method also includes determining a user layer dependent on the measurement values. The method further includes determining that the object is between the user layer and the time of flight sensor dependent on the measurement values. The method additionally includes calculating for every time frame a position in lateral directions of the object with a weighted average function dependent on the measurement values. The positions in lateral directions of the object are representative for the trajectory of the object.

The present application relates to a method for calculating a trajectory of an object with a low resolution time of flight sensor with pixels arranged in lateral directions next to one another, a system, a computer program and a computer-readable storage medium.

Identification and localization of a trajectory of a hand can represent a first step in, for example, user interface solutions or automatic human behaviour detection algorithms.

Typically, an input for calculating such a trajectory is an RGB (short for “Red Green Blue”) image, RGB-D (short for “Red Green Blue Depth”) frames or IR (short for “Infrared”) frames, captured with cameras, depths sensors or IR cameras, wherein the resolution of such sensors is usually around 640×480 pixels or bigger. Furthermore, in order to identify and to localize such a trajectory, typically deep learning models are used, which are trained with a large, annotated dataset.

It is an objective to provide a method in which a trajectory of an object is calculated in a particularly simple and efficient manner. It is further an objective to provide, a system and a computer program which can perform such a method. Furthermore, a computer-readable storage medium with such a computer program is to be provided.

These objectives are solved by the method and the subject matter of the independent patent claims. Advantageous embodiments, implementations and further developments are the subject matter of the respective dependent patent claims.

Initially, the method for calculating a trajectory of an object with a low resolution time of flight sensor with pixels arranged in lateral directions next to one another is provided.

The low resolution time of flight sensor is in particular a photodetector configured to detect electromagnetic radiation impinging on the time of flight sensor. In particular, the low resolution time of flight sensor is a direct time of flight sensor.

The time of flight sensor comprises, for example, pixels which are arranged next to one another in a matrix like manner, along rows and columns, within a mounting plane of the pixels. The pixels are, for example, positioned on grid points of a grid. Exemplarily, the grid can be a regular or an irregular grid. The grid is, for example, a polygonal grid, such as a triangular grid, a quadrangular grid or a hexagonal grid.

The low resolution time of flight sensor has, for example, at most 64 pixels or at most 144 pixel, which are in particular arranged in an 8×8 matrix or in a 12×12 matrix. Alternatively, the low resolution time of flight sensor has 16 pixels, which are in particular arranged in a 4×4 matrix. This is to say that the low resolution means that the time of flight sensor has at most 16 pixels, at most 64 pixels or at most 144 pixels.

Exemplarily, the pixels comprise at most a 40×30 matrix. In particular, the low resolution time of flight sensor has at most 1200 pixel.

Each pixel comprises at least one single photon avalanche diode (short “SPAD”), which is configured to detect electromagnetic radiation in an infrared wavelength range. It is conceivable that several SPADs are part of at least one of the pixels or each of the pixels. Exemplarily, an amount of SPADs is the same for each of the pixels or an amount of SPADs is different for at least some of the pixels.

An integrated circuitry is configured to measure an arrival time of photons of the electromagnetic radiation, wherein a time-to-digital converter (TDC) is used. The TDC is in particular configured to determine a time of arrival of photons of the electromagnetic radiation within a specific uncertainty.

Exemplarily, a resolution of the low resolution time of flight sensor is 4×4. The low resolution time of flight sensor is, for example, operated a sampling frequency at 30 Hz or 15 Hz.

According to at least one embodiment of the method, measurement values of the pixels are provided for different time frames. Each time frame has a predetermined length in time, wherein the lengths of the time frames are in particular equal to one another.

For example, the measurement values are generated using a time-correlated single photon counting (short for “TCSPC”). For the TCSPC, an emitter is, for example, configured to emit multiple pulses of electromagnetic radiation to a scene, where at least one element or no element is located. Each measurement value of each pixel is characteristic for a series of pulses within the time frame represented as a histogram corresponding to the time of arrival of individual photons of the electromagnetic radiation incident on the SPADs of the pixel—e.g., being reflected by the at least one element or not being reflected by an element. If the electromagnetic radiation is reflected by the at least one element, the histogram has in particular a peak centred around a depth value, i.e. a location in vertical direction, of the at least one element within the corresponding time frame. If the electromagnetic radiation is not reflected by an element, the histogram has in particular no peak.

Exemplarily, a height of the histogram is representative of the uncertainty of the TDC as well as further uncertainties arising from each of the pulses, the SPAD and the integrated circuit within the time frame. For example, the height is characteristic for a confidence value of the depth value.

In particular, positions of the pixels in lateral directions are characteristic for positions in lateral directions of the at least one element within the scene and the depth values of the pixels are characteristic of a position in vertical direction of the at least one element within the scene.

Exemplarily, a field of view of the time of flight detector covers a part of the scene. In particular, the field of view of the time of flight sensor is characteristic for a solid angle through which the time of flight sensor is sensitive to the electromagnetic radiation which can be reflected by the at least one element.

According to at least one embodiment of the method, a user layer is determined dependent on the measurement values. The user layer is, for example, indicative for the at least one element in the field of view or no element in the field of view.

According to at least one embodiment of the method, it is determined that the object is between the user layer and the time of flight sensor dependent on the measurement values. For example, the object is a hand located within the scene and the field of view.

Typically, the object, in particular the hand, moves in time comparatively fast with respect to an element in the user layer or the user layer itself. The object, in particular the hand, is detected dependent on the measurement values being characteristic for a movement of the hand, for example, if the measurement values are indicative of a comparatively fast movement of the object.

According to at least one embodiment of the method, for every time frame a position in lateral directions of the object is calculated with a weighted average function dependent on the measurement values. In particular, the weighted average function is an analytical function. The measurement values as well as the corresponding positions of the pixels in lateral directions are the input for the weighted average function.

According to at least one embodiment of the method, the positions in lateral directions of the object are representative for the trajectory of the object. In particular, the position in lateral directions of the object is calculated for each time frame, resulting in a series of positions of the object in the lateral directions. For example, the series is characteristic for a chronological order of the time frames. This results in the series of positions in the lateral directions of the object being characteristic for the trajectory of the object in the lateral directions.

According to one embodiment of the method for calculating a trajectory of an object with a low resolution time of flight sensor with pixels arranged in lateral directions next to one another, the method comprises providing measurement values of the pixels for different time frames, determining a user layer dependent on the measurement values, determining that the object is between the user layer and the time of flight sensor dependent on the measurement values, and calculating for every time frame a position in lateral directions of the object with a weighted average function dependent on the measurement values. The positions in lateral directions of the object are representative for the trajectory of the object.

In particular, the method is performed in the order indicated. Further, the method is in particular a computer implemented method.

An idea is, inter alia, to provide a method for calculating a trajectory of an object with a low resolution time of flight sensor, which is based on a simple signal processing calculation, i.e. being solely based on the weighted average function. Such a method has advantageously a comparatively low computational cost and is advantageously particularly fast.

Furthermore, since the calculation is based on the weighted average function being an analytical function, the method and thus also the calculation is advantageously directly interpretable and explainable, in comparison to deep learning models and artificial intelligences.

According to at least one embodiment of the method, the user layer is characteristic for a user or a background.

Within the scene and within the field of view, a user and/or a background is located. In particular, the user comprises a torso of the user and/or a head of the user. In particular, the background comprises a wall and/or a ceiling. The at least one element within the scene and the field of view is in this case in particular the torso of the user and/or the head of the user and/or the wall and/or the ceiling. The user layer is characteristic for a distance of the at least one element to the time of flight sensor in vertical direction.

Typically, the at least one element of the user layer does not move in time comparatively fast. The user layer is detected dependent on the measurement values being characteristic for a movement of the user or being characteristic for the background. This is that the user layer is detected if the measurement values are not indicative of a comparatively fast movement of the at least one element.

The user layer is defined with respect to the user or the background, for example. For example, the user layer has a predetermined depth. Exemplarily, the user or the background each extend in lateral directions and correspond to a minimal depth value of the user or the background. The predetermined depth extends from the user layer, for example, in direction facing away from the time of flight sensor.

For example, the predetermined depth in vertical direction of the user layer is at least 10 cm and at most 60 cm, approximately 30 cm.

According to at least one embodiment of the method, the user layer is an end plane of a field of view of the low resolution time of flight sensor. If there is no element in the field of view, the user layer is indicative for the end plane of the field of view. The end plane extends, for example, in lateral directions, and has a predetermined distance from the time of flight sensor in vertical direction.

For example, the predetermined distance of the end plane is at least 100 cm and at most 500 cm, approximately 180 cm.

According to at least one embodiment of the method, the determination that the object is between the user layer and the time of flight sensor dependent on the measurement values comprises a determination that the object is in a gesture area. Exemplarily, the gesture area is characteristic for a predetermined area in a cross section of the field of view parallel to the vertical direction. The gesture area is defined, for example, from a minimum predetermined gesture distance to a maximum predetermined gesture distance in vertical direction. In particular, the minimum predetermined gesture distance is smaller than the maximum predetermined gesture distance and both are smaller than the predetermined distance of the end plane.

For example, the gesture area is characteristic for a distance range in the field of view, defined by the minimum predetermined gesture distance and the maximum predetermined gesture distance, in which the object is expected to be detected.

In particular, the calculation of the position starts if the measurement values are characteristic for a distance of the object being in the gesture area. Further, the calculation starts if the measurement values are characteristic for a distance of the object being smaller than the distance of the at least one element, e.g., the user and/or the background.

The calculation stops when there is no measurement value characteristic for the object within the gesture area anymore, or when the object is in the gesture area for a predetermined time interval being in particular comparatively long. For example, the predetermined time interval is at least 1 s and at most 10 s, approximately 3 s.

Exemplarily, for determining that the object is between the user layer and the time of flight sensor and subsequently for calculating the position, the object is determined to be at the foreground in the field of view, the object is in the gesture area and the object is in the gesture area for an amount of time smaller than the predetermined time interval.

That the object is determined to be at the foreground in the field of view means, for example, that the object is the closest object to the time of flight sensor in the field of view, among the other possible elements. That the object is in the gesture area means, for example, that the object can enter the gesture area at a distance from the time of flight sensor significantly smaller than the element that was previously in the foreground.

According to at least one embodiment of the method, a distance range of the gesture area is dynamically adjusted dependent on the measurement values.

If the object is not in the gesture area, i.e. if there are no measurement values characteristic for the object to be within the distance range, the minimum predetermined gesture distance and/or the maximum predetermined gesture distance is adjusted dynamically. The adjusting is, for example, dependent on a latest measurement value, e.g. the distance of the user layer and/or a predetermined value. For example, the predetermined value is at least 5 cm and at most 30 cm, approximately 12 cm.

Advantageously, this allows to detect the object in situations where no element is in the field of view except the object, but also where both the user or the background and the object are in the field of view.

According to at least one embodiment of the method, a position in vertical direction of the object is calculated for every time frame with the weighted average function dependent on the measurement values. The measurement values as well as the corresponding positions of the pixels in vertical directions are the input for the weighted average function.

According to at least one embodiment of the method, the positions in vertical direction are representative for the trajectory of the object. In particular, the position in vertical direction of the object is calculated for each time frame, resulting in a series of positions of the object in the vertical direction. This results in a series of positions in the vertical directions of the object being characteristic for the trajectory of the object in the vertical direction.

In particular, the positions in the lateral directions and the vertical direction are representative for the trajectory of the object.

According to at least one embodiment of the method, each measurement value comprises for each pixel and each time frame a depth value in vertical direction and a confidence value. For example, the depth value is characteristic for the peak of the histogram of each pixel of each time frame and the confidence value is characteristic for the height of the histogram of each pixel of each time frame.

In particular, the depth value is representative for a distance to the time of flight sensor. Further, the confidence value is representative for an accuracy of the measurement. The confidence values can range from 0 to 255, in particular being characteristic for a lowest confidence of measurement and a highest confidence of measurement, respectively.

Exemplarily, for calculating the positions, the measurement value for each pixel are filtered based on the gesture area. For example, the measurement values, i.e. the depth value and the confidence value of each pixel, characteristic for a distance outside the gesture area, are set to 0.

For example, if the measurement values are characteristic for not measuring any depth value in a pixel, then the depth value and confidence value of the pixel is set to 0.

Advantageously, information not containing information related with the object are thus neglected and thus saving resources.

According to at least one embodiment of the method, the user layer is determined dependent on the measurement values for different time frames, if a change in the measurement values is smaller than a predetermined threshold. The change is, for example, representative for a movement of the user being characteristic for a derivative of the depth values.

Exemplarily, the derivative is characteristic for a change in vertical direction. In this case, when for different time frames, the derivatives of the depth values for each of at least some of the pixels do not exceed the predetermined threshold, the depth values are characteristic for the user layer. For example, at least some of the pixels are at least 10% or at least 50% of the pixels.

Exemplarily, the derivative is additionally or alternatively characteristic for a change in lateral directions. In this case, when for different time frames the derivative of the depth values along at least some of the pixels does not exceed the predetermined threshold, the depth values are characteristic for the user layer. For example, at least some of the pixels are at least 10% or at least 50% of the pixels.

According to at least one embodiment of the method, the object is determined to be between the user layer and the time of flight sensor dependent on the measurement values for subsequent time frames. In particular, the object is determined to be between the user layer and the time of flight sensor dependent on a comparison of the measurement values of a previous time frame and a current time frame.

Exemplarily, if the object is not detected to be within the gesture area in the current time frame, the maximum predetermined gesture distance is adjusted for each pixel to an adjusted maximum gesture distance.

According to at least one embodiment, the object is determined if a first condition and a second condition are fulfilled, wherein the first condition is fulfilled when the depth value of a current time frame of at least one pixel is smaller than any of the depth value of a previous time frame of every pixel.

The object is determined, i.e. detected, to be between the user layer and the time of flight sensor, if the first condition and the second condition is fulfilled, in particular when the object is not detected in the previous time frame. Exemplarily, the object is detected when the first condition and the second condition are fulfilled for at least K frames of N previous time frames, wherein K is smaller or equal to N.

The first condition is in particular that the current depth value of at least one pixel is significantly smaller than any of the previous depth values of the previous time frame of every pixel. Significantly means here and in the following that the current depth value of the at least one pixel is smaller than the minimum depth value, except 0, of all the pixels of the previous time frame, minus a margin, exemplarily equals to 5 cm.

Exemplarily, the first condition is fulfilled if a pixel i among all the pixels of the current time frame, is fulfilling the following condition for all the pixels j of the previous time frame: dᵢ(t)−dⱼ(t−1) is smaller than a distance threshold, e.g. being approximately 5 cm, wherein d represents a depth value. In case nothing was detected on some pixels of the previous time frame, the condition is assumed to be filled for them. The distance threshold is, for example dependent on a frequency of the time of flight sensor.

According to at least one embodiment, the first condition is fulfilled alternatively when the depth value of a current time frame of at least one pixel is smaller than the depth value of a previous time frame of the same pixel or a different pixel. This is in particular that the first condition is that the current depth value of at least one pixel is significantly smaller than the previous depth value of the previous time frame of the same pixel or a different pixel.

According to at least one embodiment, the second condition is fulfilled when the depth value of the current time frame of the at least one pixel is within the gesture area.

If at least one of these two conditions is not fulfilled, the object is not detected, and the gesture area is adjusted.

Optionally, if the low resolution time of flight sensor is arranged on a computer device, the object is detected if at least one further condition is fulfilled.

According to a further first condition, the object is detected only if the user and/or the background, is present in the gesture area. In particular, the gesture area is a predetermined gesture area. Advantageously, with this further first condition, the object, i.e. the hand, is not detected if nothing is present in the gesture area such that an object detection is not triggered in case of a person passing by the time of flight sensor.

According to a further second condition, a variation of the adjusted maximum gesture distances for different time frames are within a predetermined variational threshold, e.g. being small enough to detect the object. This is that the adjusted maximum gesture distances, i.e. adjusted distance ranges, are comparatively stable. Advantageously, the further second condition prevent a detection of the object in case a person is walking toward the time of flight sensor, reducing a wrong detection with such a low resolution time of flight sensor.

According to a further third condition, when the previous conditions and further conditions are all fulfilled, the object is detected only if at least one depth value is close enough from one of the previous measured depth values of this pixel.

Exemplarily, for the computer device use case, when the object enters in the field of view, it is likely that the object is not seen in all the pixels. At least some of the pixels not seeing the object, will still see the user or background. Advantageously, the further third condition helps to reduce the number of wrong object detections.

Additionally, if the object is detected in a previous time frame, according to the first and second conditions or the first and second conditions and at least one of the further conditions, the object is still detected for a subsequent time frame, if a third condition and a fourth condition are fulfilled.

The third condition is that the current depth value of the subsequent time frame of at least one pixel is within the current gesture area of the subsequent time frame.

The fourth condition is that the object is detected for a duration smaller than the predetermined time interval. The predetermined time interval is for a gesture recognition application approximately 3 s, and for a hand tracking application approximately 15 s. Advantageously, the fourth condition is to avoid persistent false detections.

If at least one of the third and fourth conditions is not fulfilled, the object is not detected, and the gesture area is again adjusted.

In particular, solely the depth values and the confidence values are used for the gesture recognition. Thus, this reduces advantageous resources.

For example, the gesture recognition method includes a background detector module and/or a user detector module, a hand detector module, a hand trajectory extraction module and a gesture classifier module. The hand detector module and the hand trajectory extraction module can be combined to a gesture detector module.

The background detector module is configured, exemplarily, to determine a distance of the at least one element, other than the hand, in the field of view based on the measurement values. Exemplarily, the background detector module outputs are used to adjust dynamically the distance range of the gesture area. In particular, the background detector module is characteristic for the method step corresponding to the determination of the user layer dependent on the measurement values.

The hand detector module is configured, exemplarily, to determine whether a hand is present in the current time frame or not, in particular dependent on the current gesture area limits as well as current measurement values of the current time frame and measurement values of the previous time frame. In particular, the hand detector module is characteristic for the method steps corresponding to the determination that the object is between the user layer and the time of flight sensor dependent on the measurement values.

The hand trajectory extraction module is configured, exemplarily, to store the corresponding time frame in a trajectory extraction buffer when the hand is being detected in the hand detector module. Once the hand is not detected anymore, the method is terminated, and it is considered that this is the end of a gesture. In particular, the hand trajectory extraction module is configured to extract a position for each time frame of the buffer. This time series of the position constitutes the hand trajectory, in particular of the gesture. In particular, the hand trajectory extraction module is characteristic for the method steps corresponding to the calculation of a position in lateral directions of the object with a weighted average function dependent on the measurement values for every time frame, wherein the positions in lateral directions of the object are representative for the trajectory of the object.

Exemplarily, the user detector module is configured to determine positions of at least one element within an at least 1 m, approximately 2 m, margin of the time of flight sensor. The user detector module is configured to analyse how these distances, e.g. the depth values, change and to confirm a presence of a user if the at least one element within this margin moves comparatively slow. In particular, the user detector module is characteristic for the method step corresponding to the determination of the user layer dependent on the measurement values.

Exemplarily, the gesture detector module is configured to detect and identify whether the user is presenting their hand in front of the user or not. When the hand is detected for the first time, a gesture is detected as ongoing and the gesture detector module stores the measurement values for all the time frames in an internal buffer, until the hand is not detected anymore. In particular, when the gesture is ongoing, the user, in particular a position of the at least one element, is not updated anymore since it is corrupted by the presence of the hand. In particular, the hand detector module is characteristic for the method steps corresponding to the determination that the object is between the user layer and the time of flight sensor dependent on the measurement values as well as the method step corresponding to the calculation of a position in lateral directions of the object with a weighted average function dependent on the measurement values for every time frame, wherein the positions in lateral directions of the object are representative for the trajectory of the object.

Exemplarily, the buffer comprising the determined measurement values for the time frames for the gesture is passed to the gesture classifier. Further, a trajectory of the hand is extracted. Subsequently, the trajectory can be an input of a machine learning model and/or a deep learning model, able to classify such trajectory as one of the following classes, e.g. forming the gesture vocabulary: swipe left, swipe right, swipe up, swipe down, hand tap, hand double tap, no gesture.

“No gesture” is, for example, characteristic for an action such as drinking, touching the face, stretching.

In particular, once the gesture is classified, the buffer is cleared, and the method can restart updating, exemplarily the position of the user.

According to at least one embodiment of the method, the object is determined to be between the user layer and the time of flight sensor dependent on a peak value of a derivative of the depth values for different time frames. In particular, the peak value is characteristic for the object being moved in or out of the field of view of the time of flight sensor.

If the object is moved in the field of view of the time of flight sensor, the derivative of the depth values is negative for at least one of the pixels for different time frames. If the object is moved out of the field of view of the time of flight sensor, the derivative of the depth values is positive for at least one of the pixels for different time frames.

For example, the corresponding peak value is determined, if the derivative for one or several of the pixels is larger than the predetermined threshold.

According to at least one embodiment of the method, the calculation of the trajectory is started if the object is determined to be between the user layer and the time of flight sensor, if the peak value is negative.

According to at least one embodiment of the method, the calculation of the trajectory is terminated, if the peak value is positive.

Advantageously, the method provides a dynamical distinction, if the object is between the user layer and the time of flight sensor within the field of view. If the object is between the user layer and the time of flight sensor, the trajectory of the object is subsequently calculated. When the object is subsequently removed from the field of view, the calculation is advantageously terminated in order to save computational costs.

According to at least one embodiment of the method, when the object is determined to be between the user layer and the time of flight sensor, an object layer is determined. The object layer is characteristic for a distance of the object, in particular the hand of the user.

According to at least one embodiment of the method, the object layer extends in vertical direction from a minimal depth value in direction to the user layer. The minimal depth value is, for example, characteristic for a minimal distance of the object to the time of flight sensor.

According to at least one embodiment of the method, the object layer has a predetermined depth. In particular, the predetermined depth of the object layer extends from the minimal depth value in direction to the user layer.

For example, the predetermined depth of the object layer is at least 1 cm and at most 20 cm, approximately 10 cm.

According to at least one embodiment of the method, when the trajectory is calculated, only the measurement values of the object layer are considered. This is to say that the trajectory is solely calculated dependent on the measurement values which lie in the object layer. Thus, advantageously, computational resources are effectively saved leading to computational cost savings.

Exemplary, as soon as in at least one of the pixels, there is a negative peak value being above an absolute value of the threshold value and the depth value of this at least one of the pixels is smaller than the depth values of the user layer, it is considered that the object, e.g. the hand, has entered the field of view of the time of flight sensor. In this case updating the user layer can be stopped. Only the measurement values of the object layer in the current time frame, and the following time frames, are considered until the positive peak value is detected such that again also the measurement values of the user layer are considered.

On the contrary, if there is no negative peak value in any of the pixels, the user layer is updated, such that the user layer is determined based on the measurement values of the pixels.

According to at least one embodiment of the method, each pixel has a predetermined grid value being characteristic to a position in lateral directions of the respective pixel. For example, each of the pixels extend in lateral directions in a main extension area. A shape of each main extension area in lateral directions is, exemplarily, a quadrangle, in particular a square or a rectangle. The main extension areas of neighbouring pixels are arranged directly adjacent to one another. For example, centres of the main extension areas are arranged on the grid points of the grid.

All main extension areas form a main extension region of the pixels. The main extension region extends along a first virtual x-axis and a second virtual y-axis, which are perpendicular to one another. One of the edges of the main extension region extends along the first virtual x-axis and an adjacent edge of the main extension region extends along the second virtual y-axis. For example, the main extension region extends in direction of the virtual x-axis and the virtual y-axis from a grid value 0 to a grid value 1, thus spanning up a coordination system in lateral directions.

According to such a coordination system, a predetermined grid value can be assigned to each pixel, wherein the predetermined grid values correspond to values of the respective centres of the main extension areas of the respective pixels within the coordination system.

According to at least one embodiment of the method, each grid value comprises a first component xᵢ and a second component yᵢ, where i=1 . . . n, where n is the number of pixels. Exemplarily, each xᵢ component and each yᵢ component corresponds to the respective grid values of the respective centres of the main extension areas of the respective pixels within the coordination system. This is that each xᵢ component and each yᵢ component can range from 0 to 1.

According to at least one embodiment of the method, the trajectory in lateral directions is calculated exclusively dependent on the confidence values and the grid values. This is that solely the confidence values corresponding to the depth values within the object layer or the gesture area as well as the corresponding grid values are used for calculating the trajectory of the object. Exemplarily, the confidence value of the pixels not part of the object layer or the gesture area are set to 0. Advantageously, this consumes comparatively few computational power.

According to at least one embodiment of the method, the position in lateral directions of the object comprises a first position xₒ and a second position yₒ.

According to at least one embodiment of the method, the first position xₒ is calculated for each time frame as follows:

$${x}_{o} = \frac{{\sum }_{i = 1}^{n} {x}_{i} \times {c}_{i}}{{\sum }_{i = 1}^{n} {c}_{i}} .$$

This is to say that for a single time frame for every pixel the first component xᵢ is multiplied with the corresponding confidence value cᵢ within the object layer or the gesture area. These multiplications are subsequently summed up. The sum is subsequently divided by the sum of all confidence values cᵢ within the object layer or the gesture area resulting in the first position xₒ.

According to at least one embodiment of the method, the second position yₒ is calculated for each time frame as follows:

$${y}_{o} = \frac{{\sum }_{i = 1}^{n} {y}_{i} \times {c}_{i}}{{\sum }_{i = 1}^{n} {c}_{i}} .$$

This is to say that for a single time frame for every pixel the second component yᵢ is multiplied with the corresponding confidence value cᵢ within the object layer or the gesture area. These multiplications are subsequently summed up. The sum is subsequently divided by the sum of all confidence values cᵢ within the object layer or the gesture area resulting in the second position yₒ.

The xₒ and yₒ calculations are performed for every time frame j, where j=1 . . . m, where m is the number of time frames in a time interval beginning with the starting of the calculation and the termination the calculation. This results in the trajectory with the components x_{o, j} and y_{o, j}.

According to at least one embodiment of the method, each pixel has a third component zᵢ being characteristic for the depth value of the respective pixel, where i=1 . . . n, where n is the number of pixels.

According to at least one embodiment of the method, the position in vertical direction of the object comprises a third position zₒ.

According to at least one embodiment of the method, the third position zₒ is calculated for each time frame as follows:

$${z}_{o} = \frac{{\sum }_{i = 1}^{n} {z}_{i} \times {c}_{i}}{{\sum }_{i = 1}^{n} {c}_{i}} .$$

This is to say that for a single time frame for every pixel, which has a depth value within the object layer or the gesture area, the third component zᵢ is multiplied with the corresponding confidence value cᵢ within the object layer or the gesture area. These multiplications are subsequently summed up. The sum is subsequently divided by the sum of all confidence values cᵢ within the object layer or the gesture area resulting in the third position zₒ.

The zₒ calculation is performed for every time frame resulting in a third component of the trajectory with the component z_{o, j}.

Exemplarily, the measurement values are set to 0 for the pixels, where the depth values are not within the gesture area of the current time frame. Optionally, the measurement values of the pixels, where the depth values are above a minimum depth value of the frame, except 0, plus a predetermined margin, can also be set to 0. The predetermined margin is, for example, approximately 15 cm.

In particular, a correction, a filtering and/or a smoothing function can be applied to zᵢ before computing the weighted average.

According to at least one embodiment of the method an end point of the trajectory of the object is displayed on a screen. This is that the trajectory is calculated dynamically for every time frame up to the presence. The end point is the point of the trajectory of the last time frame. For example, the end point represents a cursor on the screen.

This is, in particular, that a method for hand tracking is provided, wherein the trajectory of the object, which is calculated according to the method described herein before, is mapped to a screen of a computer device, in particular to move a cursor and interact with virtual object on the screen.

The method can be in particular used as a user interface tool. In this case, the hand of the user can be mapped to the position of the cursor on the screen, allowing the user to move and interact with, e.g., virtual objects on the screen with his hand.

In particular, a method for a slider control is provided, wherein the user is able to set a value, e.g. from 0 to 100, by moving the hand in front of the time of flight sensor with the method. This is implemented, for example, by a circular slider and/or a push/pull slider. The circular slider is characteristic for setting the value by moving the hand in a circular movement. In particular, angles from 0° to 360° of a circle are mapped to the values between 0 and 100. The push/pull slider is characteristic for setting the value by moving the hand along the vertical direction, i.e. the axis between the hand and the time of flight sensor).

Furthermore, a method for gesture recognition is provided, wherein the trajectory of the object, which is calculated according to the method described herein before, is provided for a machine learning model, in particular an artificial intelligence, e.g. a neural network.

In particular, the first position, the second position and the third position of each time frame can be stored in a buffer while the object is being detected and the positions are calculated. Once the object is not detected anymore and the calculation is terminated, the trajectory can subsequently be classified using, for example, the machine learning model, taking as input the trajectory, and outputting a corresponding gesture name.

The neural network is, e.g. a Long-Short-Term-Memory, LSTM, network. To train the LSTM network a dedicated dataset is generated. To train the neural network, the dataset is exemplarily split into two sets, a training set used to train the LSTM and a validation set used to ensure that the neural network is not overfitting the training set.

Exemplarily, at least some gestures are considered as invalid and rejected from the dataset. For example, the training set and the validation set each have a classification accuracy of at least 95%.

To test the method, a predetermined dataset is generated, for example. The predetermined dataset comprises, for example, several gesture recognition sessions characteristic for a user performing several gestures in a row. The predetermined dataset comprises, for example, several users, at several different distances. Exemplarily, the predetermined dataset comprises recordings of people doing other gestures that are supposed to be discarded by the method, such as touching their glass, drinking from a glass or simply just passing by.

Advantageously, this can be used to trigger an action on a computer device, in particular a screen. Exemplarily, switching slides of a presentation by doing gestures to the left or the right.

Exemplarily, the gesture recognition or the slider control are stated dependent on a trigger to switch from one mode to the other. Dependent on the trigger the gesture recognition or the slider control are performed, for example. Exemplarily, a switching between the gesture recognition and the slider is carried out dependent on the trigger. Exemplarily, the gesture provides results when the end of a gesture is detected, whereas for the slider control the hand is continuously tracked.

The trigger for the slider control is, for example, characteristic for moving the hand forward in front of the sensor and keep it still for a predetermined amount of time. The determination, i.e. the detection, of the hand is carried out while the method is in gesture recognition mode.

Furthermore, a system for calculating a trajectory of an object with a low resolution time of flight sensor with pixels arranged in lateral directions next to one another is provided.

The system is configured to perform the method described herein. All features of the embodiment disclosed in connection with the method are therefore also disclosed in connection with the system and vice versa.

The system comprises, for example, an optoelectronic component. The optoelectronic component is, for example, configured to emit electromagnetic radiation and to detect the emitted electromagnetic radiation after being reflected by the at least one element. In particular, the optoelectronic component is configured to provide the measurement values.

The optoelectronic component comprises, for example, an emitter. The emitter has, for example, at least one vertical cavity surface emitting laser (short “VCSEL”). In particular the VCSEL is a pulsed VCSEL, configured to emit electromagnetic radiation as pulses of a predetermined duration at a predetermined repetition rate. The VCSEL is configured to emit electromagnetic radiation in an ultraviolet wavelength range, in a visible wavelength range and/or in an infrared wavelength range. Exemplarily, the VCSEL emits laser radiation in a field to be illuminated of approximately 940 nm.

The optoelectronic component further comprises the low resolution time of flight sensor described herein above. The time of flight sensor further comprises, for example, an optical element arranged on the time of flight sensor. The optical element has, in particular, a multi-lens optics. The optical element is configured, for example, to direct the emitted electromagnetic radiation—after being reflected by the at least one element—to the pixel. Exemplarily, a volume of a packaged time of flight sensor is at most 2.0 mm×4.6 mm×1.4 mm.

The time of flight sensor further comprises, for example, an optical filter element which is configured to absorb and/or block electromagnetic radiation in an ultraviolet wavelength range and/or in a visible wavelength range.

Exemplarily, the optical filter is placed in front of the time of flight sensor in order to reduce noise caused by ambient light. The optical filter is not mandatory and advantageously mainly increase performance in very bright setups, such as outside or next to a window with sunrays hitting the time of flight sensor.

For example, the optoelectronic component further comprises an integrated circuitry. The integrated circuitry is, for example, an on-chip microcontroller. The integrated circuitry is configured for histogram processing in the optoelectronic component.

The vertical cavity surface emitting laser and the time of flight sensor as well as the on-chip microcontroller are in particular part of the same optoelectronic component. Exemplarily, the vertical cavity surface emitting laser, the time of flight sensor ant the on-chip microcontroller are mounted on a same base, in particular a same substrate and/or carrier.

Exemplarily, optoelectronic component has a width of at most 2.0 mm, a length of at most 5 mm and/or a thickness of at most 1.5 mm.

Additionally, the system comprises an evaluation device, for example. The evaluation device is in particular configured to perform the method described herein before. The evaluation device is, for example, part of the optoelectronic component or an external device.

It is conceivable, that the optoelectronic component is part of a camera device, which additionally comprises a video device, such as a video camera and/or a webcam. For example, the vertical cavity surface emitting laser and the time of flight sensor and/or the on-chip microcontroller are arranged adjacent to the video device.

Furthermore, a computer program is provided comprising instructions which, when the computer program is executed by a computer, cause the computer program to perform the method described herein.

Furthermore, a computer-readable storage medium is provided on which the computer program described herein is stored.

Exemplarily, the method is converted to be advantageously comparatively small to fit in an embedded platform.

In the following, the method and the system are explained in more detail with reference to the Figures by means of exemplary embodiments.

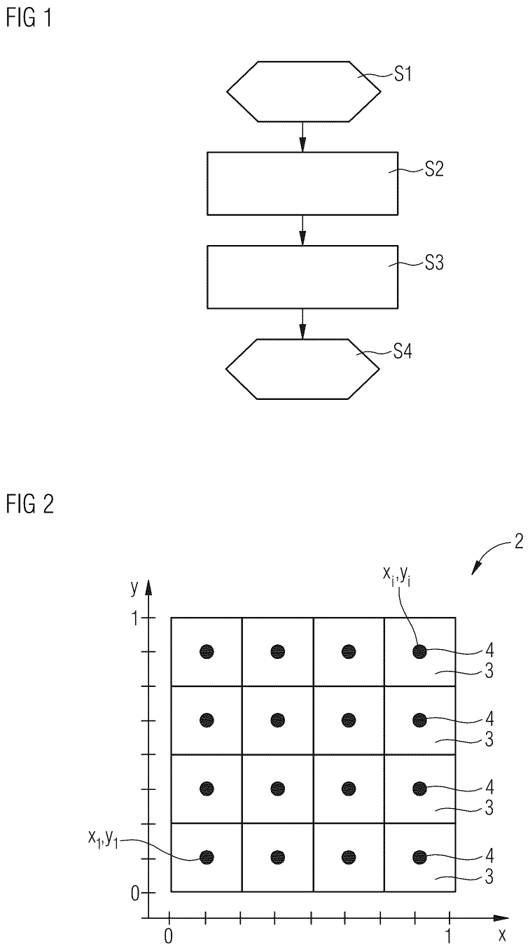

FIG. 1 shows a flow chart diagram of an exemplary embodiment of the method.

FIG. 2 shows the pixel of the time of flight sensor according to an exemplary embodiment of the method.

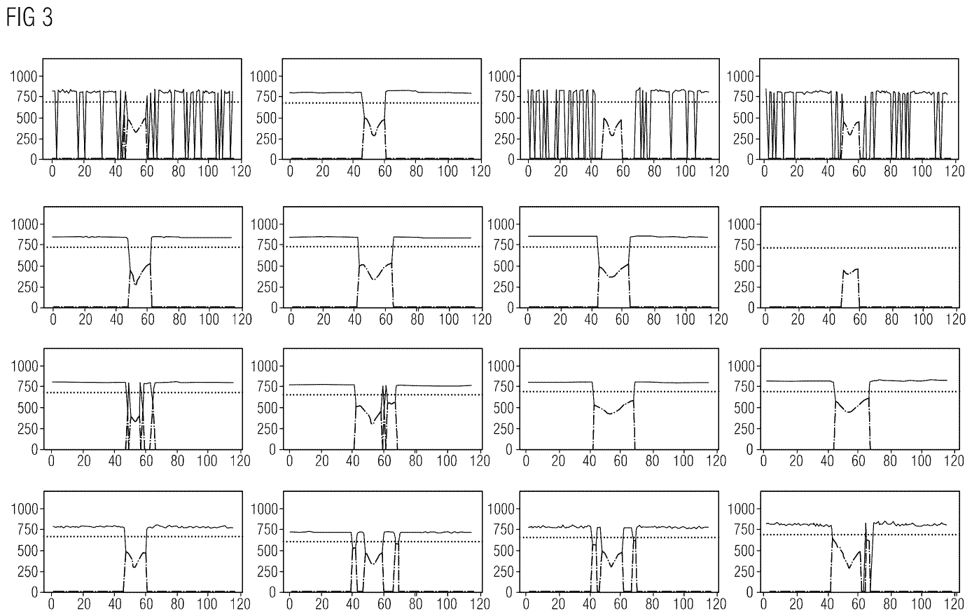

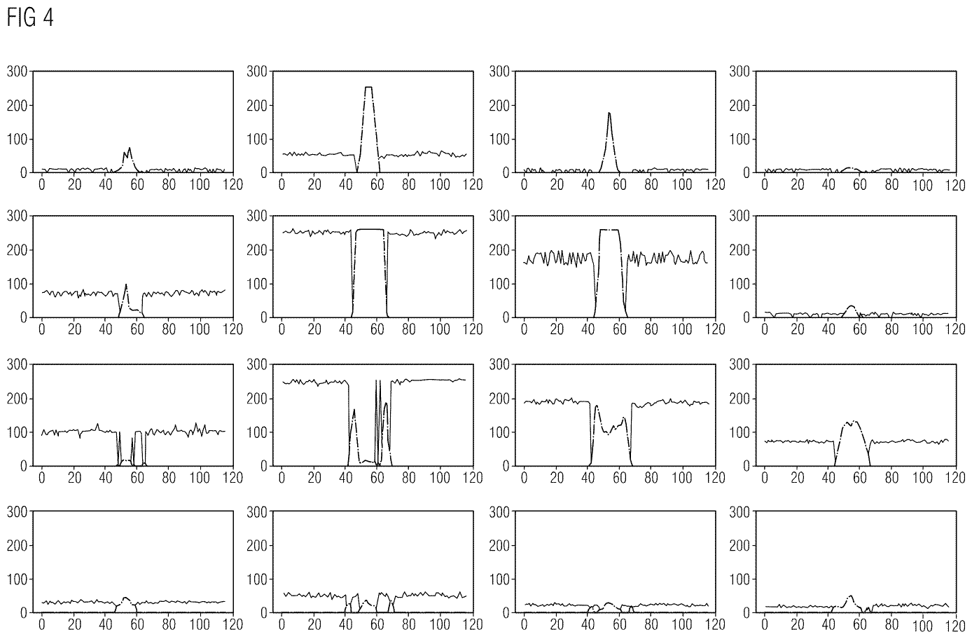

FIGS. 3 and 4 each shows exemplary diagrams of the measurement values of the pixels of the time of flight sensor according to an exemplary embodiment of the method.

FIG. 5 shows an exemplary trajectory of the first object according to an exemplary embodiment of the method.

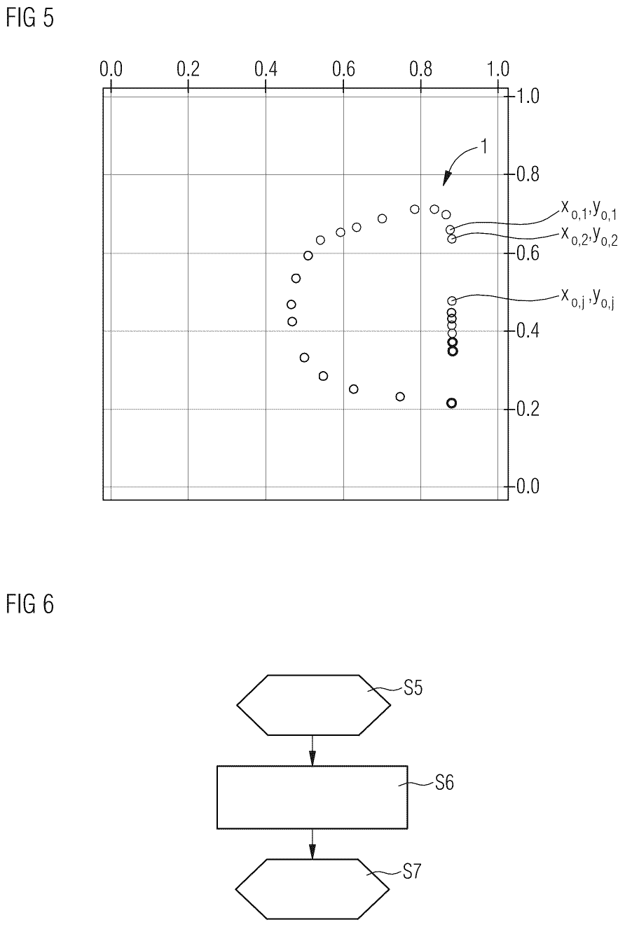

FIG. 6 shows a flow chart diagram of an exemplary embodiment of the method.

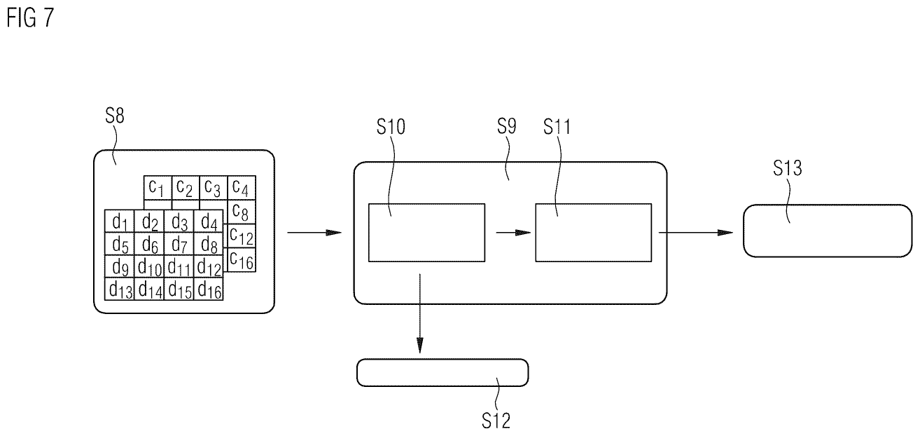

FIG. 7 shows a flow chart diagram of an exemplary embodiment of the method.

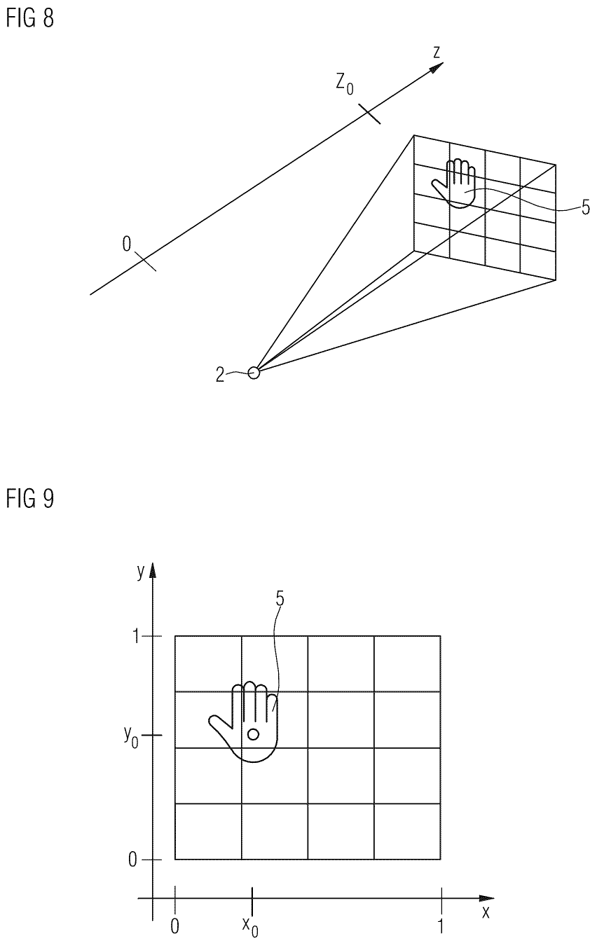

FIGS. 8 and 9 shows the pixels of the time of flight sensor and a field of view with the object according to an exemplary embodiment of the method.

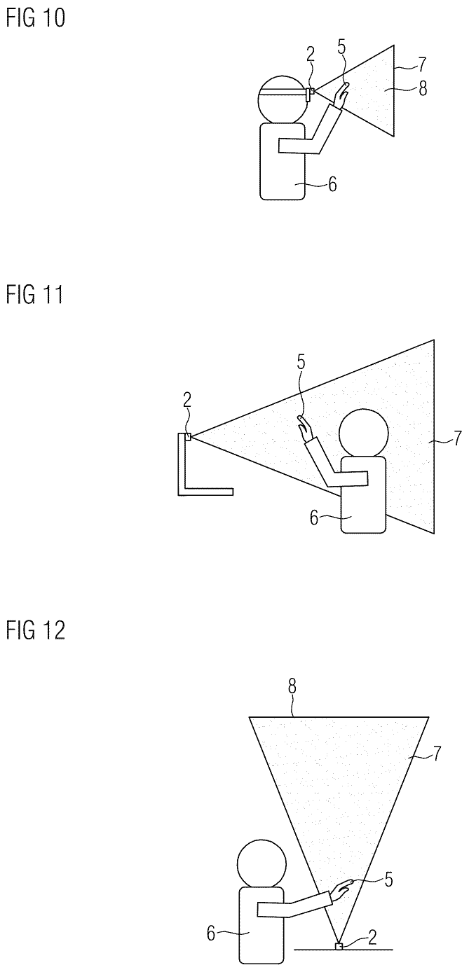

FIGS. 10 to 28 describe different use cases for the method according to an exemplary embodiment.

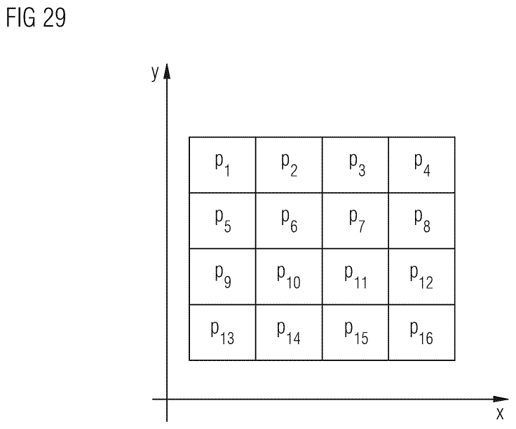

FIG. 29 indicates indices of pixels of a low resolution time of flight sensor with a 4×4 resolution.

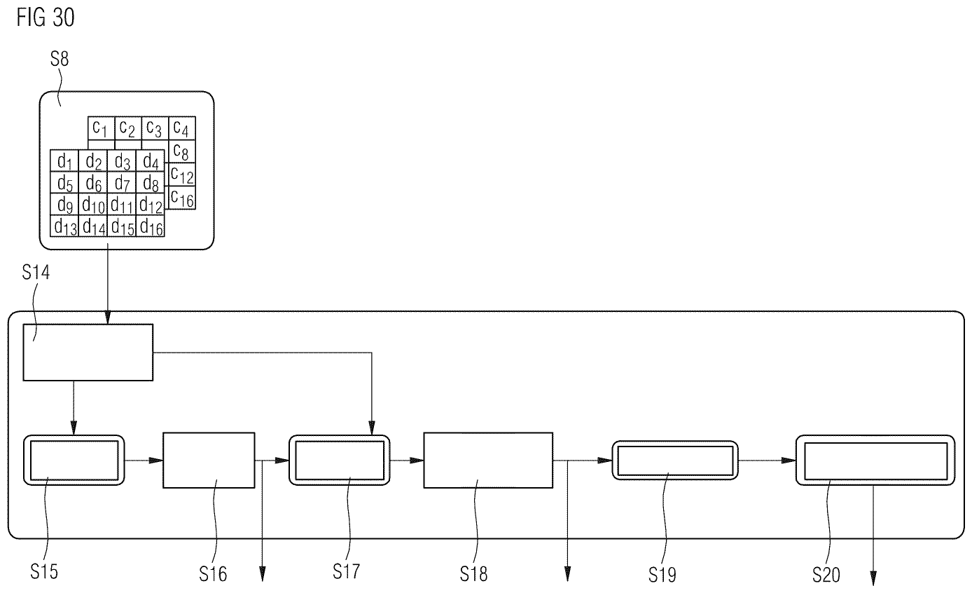

FIGS. 30 to 36 describe a gesture recognition method according to an exemplary embodiment.

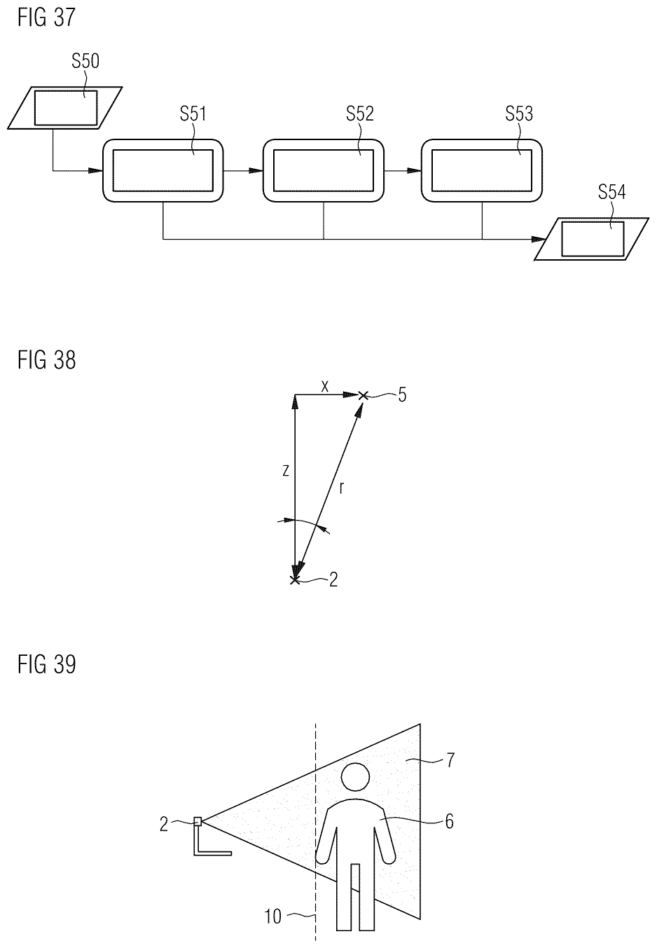

FIGS. 37 to 52 describe a gesture recognition method according to an exemplary embodiment.

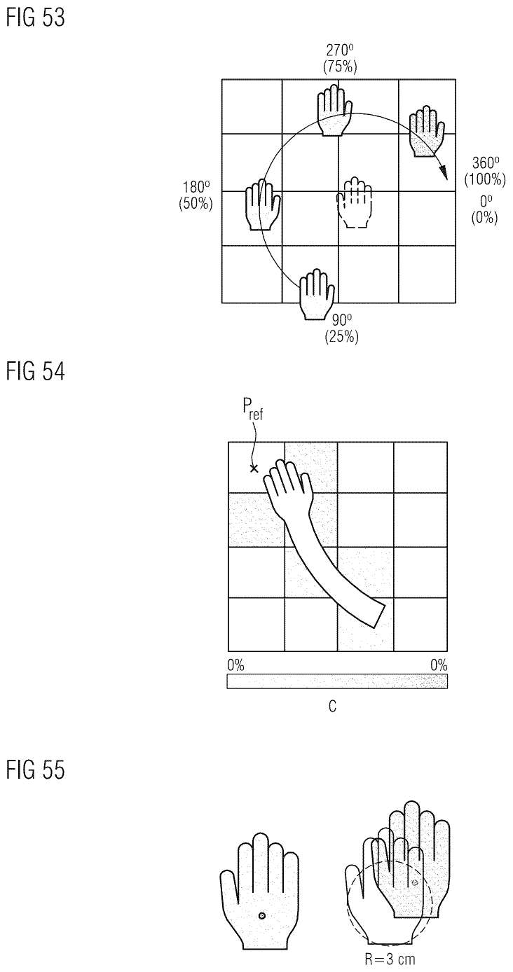

FIGS. 53 to 55 describe a circular slider method according to an exemplary embodiment.

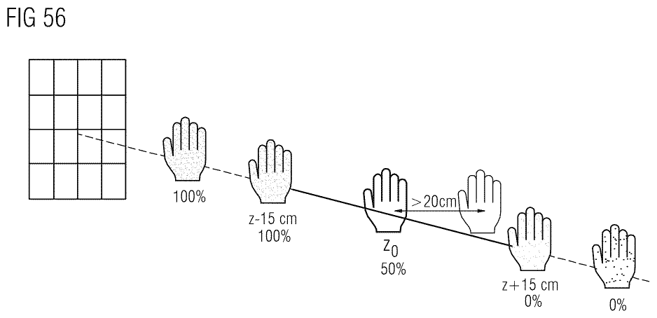

FIG. 56 describes a push/pull slider method according to an exemplary embodiment.

Elements that are identical, similar or have the same effect are given the same reference signs in the Figures. The Figures and the proportions of the elements shown in the Figures are not to be regarded as to scale. Rather, individual elements can be shown exaggeratedly large for better representability and/or for better comprehensibility.

In the flow chart diagram of the method for calculating a trajectory 1 of an object with a low resolution time of flight sensor 2 with pixels 3 arranged in lateral directions next to one another according to the exemplary embodiment of FIG. 1, initially, measurement values of the pixels 3 for different time frames are provided in a method stage S1.

The measurement values comprise for each pixel 3 and each time frame a depth value in vertical direction, being perpendicular to the lateral directions, and a confidence value.

The time of flight sensor 2 comprises, for example, 16 pixels 3, being arranged adjacent to one another and in a matrix like manner, along rows and columns. In particular, the pixels 3 are arranged in a 4×4 matrix, as shown in connection with FIG. 2. Positions of the pixels 3 in lateral directions are characteristic for positions in lateral directions of at least one element to be detected by the pixels 3 and the depth values of the pixels 3 are characteristic of a position in vertical direction of the at least one element to be detected by the pixels 3.

According to the method stage S2, a user layer is determined dependent on the measurement values. The user layer is characteristic for a distance of a user, a background or an end plane of the field of view of the time of flight sensor 2.

Subsequently, in the method stage S3, it is determined that the object, in particular a hand, is between the user layer and the time of flight sensor 2 dependent on the measurement values. If a peak value of a derivative of the depth values for different time frames is negative, the negative peak value is characteristic for the object being moved in the field of view of the time of flight sensor 2. In this case it is determined that the object is between the user layer and the time of flight sensor 2 in vertical direction.

In the method stage S4, a position in lateral directions of the object is calculated for every time frame with a weighted average function dependent on the measurement values, wherein the positions in lateral directions of the object are representative for the trajectory 1 of the object.

The pixels 3 of the low resolution time of flight sensor 2 according to the exemplary embodiment of FIG. 2 are arranged adjacent to one another on grid points 4 of a grid. The grid is in particular a squared grid or a rectangle grid. The pixels 3 are arranged along rows and columns, in particular in a 4×4 matrix.

Each of the pixels 3 extend in lateral directions in a main extension area having a shape of a square. In this case, centres of the main extension areas are arranged on the grid points 4. Outer edges of the pixels 3 extend along a first virtual x-axis x and a second virtual y-axis y, which are perpendicular to one another, spanning up a coordination system ranging from 0 to 1 for x and y.

Furthermore, each pixel 3 has a predetermined grid value being characteristic to a position in lateral directions of the respective pixel 3, i.e. the respective grid points 4 within the coordination system.

In particular, each grid value comprises a first component xᵢ and a second component yᵢ, where i=1 . . . n, where n is the number of pixels 3. Therefore, each pixel 3 can be assigned to a single grid value, wherein the grid value corresponds to the centre or the grid point 4 within the coordination system x, y. This is, for example, the components of the grid value of the pixel 3 at the bottom left corner are x₁=0.125 and y₁=0.125. The grid values of the remaining pixels 3 are determined accordingly.

When calculating the trajectory 1 of the object according to method stage S4 in FIG. 1, for a single time frame for every pixel 3 the first component xᵢ is multiplied with the corresponding confidence value cᵢ of the object, in particular within an object layer. These multiplications are subsequently summed up. The sum is subsequently divided by the sum of all confidence values cᵢ, in particular within the object layer, resulting in the first position xₒ. The calculation is performed correspondingly with the second component yᵢ. This results, for the single time frame, in the position of the object xₒ and yₒ. The values of xₒ and yₒ can be within the coordination system within the values 0 to 1.

The diagrams of FIGS. 3 and 4 exemplarily show measurement values, e.g., being acquired by the pixels 3 of the time of flight detector of FIG. 2. Each diagram corresponds to one of the pixels 3, in particular at the position in lateral directions. A time is indicated on the x-axis for the diagrams of FIGS. 3 and 4. In FIG. 3, depth values of the pixels 3 are indicated on the y-axis and in FIG. 4, the respective confidence values of the pixels 3 are indicated on the y-axis.

In each diagram three curves are plotted, wherein the curve displayed as a straight line represents a raw signal of the pixels 3, the curve displayed as a dotted line represents measurement values of the user layer, in particular a lower boundary of the user layer, and the curve displayed as a dash-dotted line represents measurement values of the object within the object layer.

As described in connection with FIG. 2, solely the confidence values of the measurement values are used to calculate the position in lateral directions. In connection with FIG. 5, the calculation is plotted within the coordination system, i.e., the positions of the object xₒ and yₒ are plotted for different time frames j. This results in the trajectory 1 of the object.

In the flow chart diagram of the method for gesture recognition according to the exemplary embodiment of FIG. 6, initially a trajectory 1 of an object, being a hand of a user, is calculated in a method stage S5 according to the method of FIG. 1.

The trajectory 1 is subsequently provided for an artificial intelligence, in particular an artificial intelligence based on a gesture recognition algorithm in method stage S6.

The artificial intelligence is, for example, trained with significant and relevant features, which are represented by corresponding predetermined hand trajectories 1. Thus, the artificial intelligence is configured in a training phase to assign a predetermined definition of a given vocabulary, i.e. a name of a gesture, to each of the predetermined hand trajectories 1. In this case, it is not necessary to train the artificial intelligence with raw data, which can contain irrelevant information. Thus, efficiency of the artificial intelligence is advantageously increased.

The artificial intelligence can subsequently map the calculated trajectory 1 to a corresponding name of the gesture.

In the method stage S7, the name of the gesture is provided as an output.

In the method stages according to FIG. 7, an input, outputs and main steps of the method are described. In method stage S8, the input is provided comprising measurement values of the pixels of the low resolution time of flight sensor for a specific time frame for a time t. The low resolution time of flight sensor has a 4×4 resolution. Further, each pixel i provides a depth value d in vertical direction and a confidence value c. This is that the measurement values in each frame comprises two subframes, i.e. a distance frame comprising the depth values d for each pixel i and a confidence frame comprising the confidence values c for each pixel i.

The main steps S9 are characteristic for calculating a position of the object, in particular corresponding to method stage S4 in FIG. 1, comprising the method stages S10 and S11.

In method stage S10, it is determined if the hand is in the field of view. If no, an output can be generated that the object is not present in the field of view in S12. If yes, method stage S11 is carried out, corresponding to the computation of the position of the object in lateral directions x, y and vertical direction z according to method stage S4 in FIG. 1. A further output can be generated that the object is present in the field of view in S13.

The field of view in FIG. 8 is spanned up dependent on the pixels of the low resolution time of flight sensor. Each pixel has a predetermined grid value being characteristic to a position in lateral directions of the respective pixel. In FIG. 9, each grid value comprises a first component x and a second component y being normalized between 0 and 1. Additionally, each pixel has a third component z, corresponding to the x and y component being characteristic for the depth value of the respective pixel. Lateral directions are defined in the x and y plane and the vertical direction is along the z direction.

The position xₒ, yₒ and zₒ of the object are calculated dependent on x, y and z.

Exemplarily, if x=0 or respectively if x=1, the object is at the extreme left or respectively right limit of the field of view. Exemplarily, if y=0 or respectively if y=1, the object is at the extreme bottom or respectively top limit of the field of view.

The low resolution time of flight sensor 2 according to FIG. 10 is arranged on a wearable, e.g. glasses or a helmet of the user 6, facing away from the user 6. The low resolution time of flight sensor 2 according to FIG. 11 is arranged on a computer device, e.g. a laptop, facing the user 6. The low resolution time of flight sensor 2 according to FIG. 12 is arranged, e.g. on a tablet or a mobile phone, wherein time of flight sensor 2 faces a ceiling.

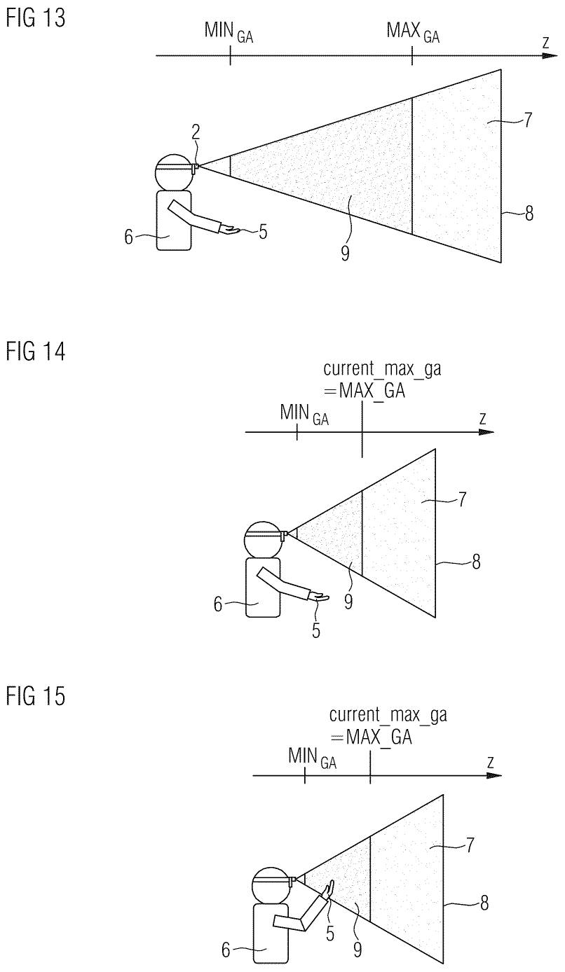

In FIG. 13 in the method according to an exemplary embodiment, a gesture area 9 is defined in the field of view 7. This gesture area 9 is the area of the field of view 7, where the object 5 has to be, to compute the position of the object 5. The gesture area 9 is defined by a minimum predetermined gesture distance MIN_{GA} and a maximum predetermined gesture distance MAX_{GA}, for each pixel.

Default values of the minimum predetermined gesture distance MIN_{GA} and the maximum predetermined gesture distance MAX_{GA} are each predetermined. In particular, the maximum predetermined gesture distance MAX_{GA}, can be adjusted dynamically, according to the measurement values of the previous time frames, as described in connection with FIGS. 14 to 20.

The object detection and the position calculation is carried out, only if the object is inside the gesture area. Exemplarily, a direction of a pixel's vertical direction is specific to each pixel, and/or the values of MIN_{GA} and MAX_{GA} is specific to each pixel.

If the object is not determined to be in the gesture area for a current time frame, the maximum predetermined gesture distance MAX_{GA} is exemplarily adjusted as follows for a subsequent time frame:

adjusted MAX_{GA},i=min(dᵢ−margin,MAX_{GA}), wherein
adjusted MAX_{GA}, i is the adjusted maximum gesture distance MAX_{GA} for the pixel i for the subsequent time frame. This value will be used to determine whether the object is in the gesture area in the subsequent time frame.

dᵢ is the measurement value of each pixel i, in particular the depth value for the current time frame. dᵢ can also be an average, or a function, of measurement values, in particular the depth values, of N last frames, where the object is not detected. It is possible, if dᵢ=0, nothing is detected in the gesture area, adjusted_MAX_{GA}, i is set to MAX_{GA}, i.

The margin is an arbitrary positive integer, representing a minimum distance gap, also called minimum velocity peak, from one time frame to another to consider that the object enters in the field of view with respect to the user layer. The margin is, for example, 12 cm.

MAX_{GA,i} is the default value of the maximum predetermined gesture distance MAX_{GA} for the pixel i.

In particular, for each pixel, the current depth value of the current time frame is compared to a depth value of the previous time frame. The object is then detected if the current depth value of at least one pixel is significantly smaller than any of the previous depth values of the previous time frame of every pixel corresponding to the user or the background or if the current depth value of at least one pixel is significantly smaller than any of the previous depth values of the previous time frame of every pixel corresponding to the end plane of the field of view, e.g. nothing is detected, and if the current depth value of the at least one pixel is within the gesture area. If at least one of these two conditions is not fulfilled, the object is not detected, and the gesture area is adjusted, as described in connection with FIGS. 14 to 20.

According to FIG. 14, the object 5 is not detected within a gesture area 9 being defined with default values for a time frame N. MAX_{GA} is indicated accordingly on the z axis.

According to FIG. 15, the object 5 of FIG. 14, being the users hand, is moved in the gesture area 9. The object is detected within the gesture area 9 being defined with the default values for a subsequent time frame N+1. MAX_{GA}, i is indicated accordingly on the z axis. Exemplarily, MAX_{GA}, i is an example where all the MAX_{GA}, i are equal to the same constant value.

In FIGS. 14 and 15, the user layer is determined to be an end plane 8 of the field of view.

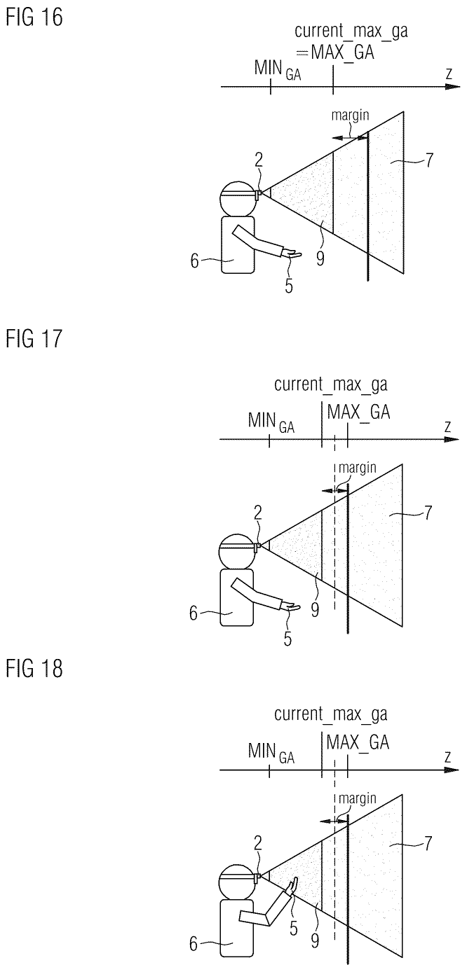

According to FIG. 16, the object 5 is not detected within a gesture area 9 being defined with default values for a time frame N. MIN_GA is indicated accordingly on the z axis, as also indicated in FIGS. 13 to 15.

In FIG. 16, as well as in FIGS. 17 and 18, the user layer 10 is determined to be a wall within the field of view, in particular being a background 11. A margin from the user layer 10 in direction to the time of flight sensor 2 is indicated accordingly on the z axis.

According to FIG. 17, the user 6 of FIG. 16, comprising the users hand, is moved towards the wall. The object 5 is not detected within the gesture area for a subsequent time frame N+1. The gesture area is adjusted for the subsequent time frame N+1, wherein the adjusted maximum gesture distance is “adjusted MAX_{GA}=background-margin”, which is indicated accordingly on the z axis.

According to FIG. 18, the object 5 of FIG. 17, being the users hand, is moved in the gesture area 9, in particular in such a way that the depth value of the pixel corresponding to the hand, is significantly smaller than any of the depth values of the previous time frame, which all corresponds to the wall. The object is detected within the gesture area with the adjusted maximum gesture distance being “adjusted MAX_{GA}=the background−margin” for a further subsequent time frame N+2.

The time of flight sensor 2 is part of a wearable, e.g. glasses of the user 6, in FIGS. 14 to 18.

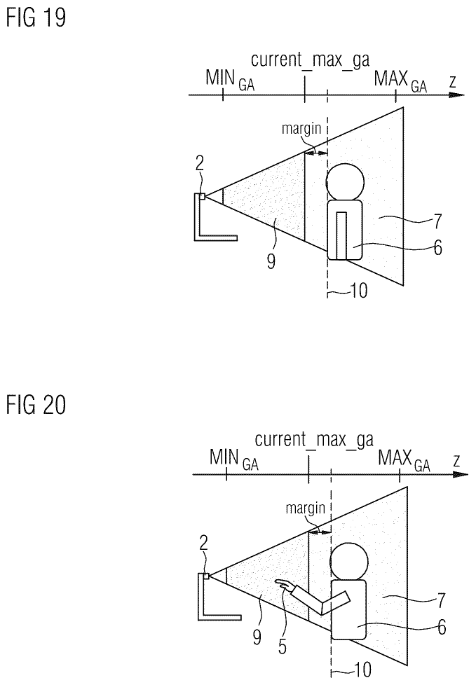

According to FIG. 19, the object 5 is not detected within the gesture area 9 for a time frame N. The gesture area is adjusted for the time frame N, wherein an adjusted maximum gesture distance is “adjusted MAX_{GA}=the user−margin”, which is indicated accordingly on the z axis.

According to FIG. 20, the object 5 of FIG. 19, being the hand of the user 6, is moved in the gesture area 9 in such way that the depth value of the pixel corresponding to the hand, is significantly smaller than any of the depth values of the previous time frame, which all corresponds to the users body and/or head. The object is detected within the gesture area with the adjusted maximum gesture distance with “adjusted MAX_{GA}=the user-margin”, which is indicated accordingly on the z axis.

The time of flight sensor is part of a computer device, e.g. a laptop, in FIGS. 19 and 20.

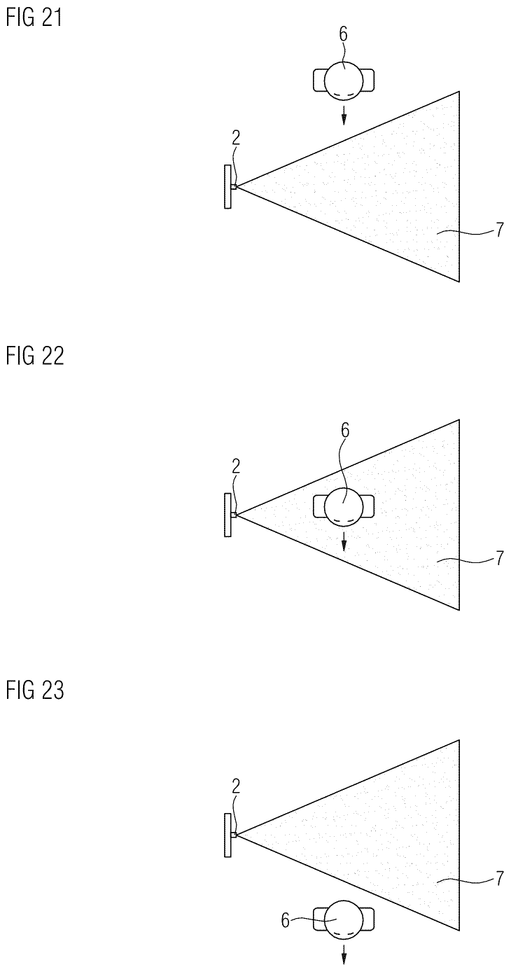

In FIGS. 21, 22 and 23, a person is passing by the time of flight sensor 2 arranged on a computer device. The object 5 is not detected as a further first condition is not fulfilled, wherein the object is detected only if the user 6 and/or the background 11 is present in the predetermined gesture area 9 between MIN_{GA} and MAX_{GA}.

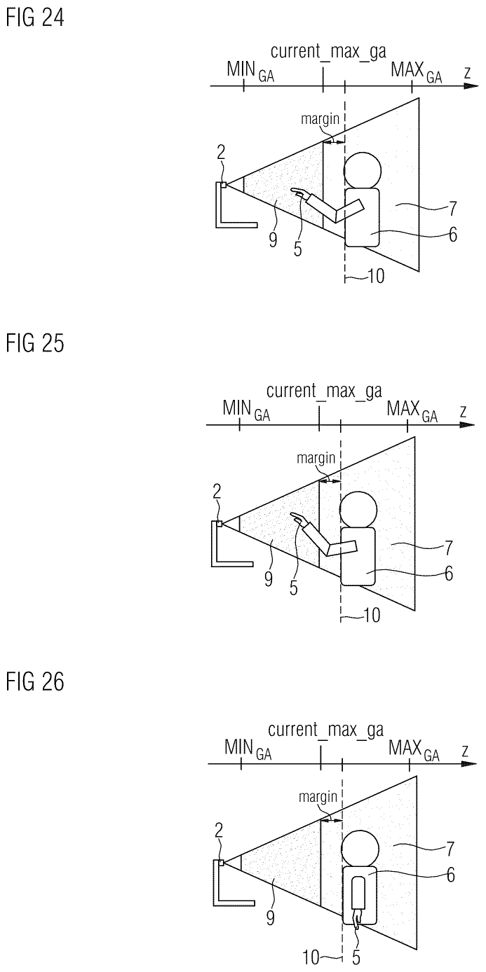

According to FIG. 24, the object 5 is detected within the gesture area 9 for a time frame N at a time T. The gesture area is adjusted for the time frame N, wherein an adjusted maximum gesture distance is “adjusted MAX_{GA}=the user−margin”, which is indicated accordingly on the z axis.

According to FIG. 25, the object 5 stays in the gesture area 9 indicated in FIG. 24 for a duration D within the gesture area, wherein the duration D is smaller a predetermined time interval. In this case the object is detected within the gesture area for a time frame N+K, K being the number of frames corresponding to the duration D.

According to FIG. 26, the object is moved out of the gesture area such that the object is not detected for a time frame N+K+1.

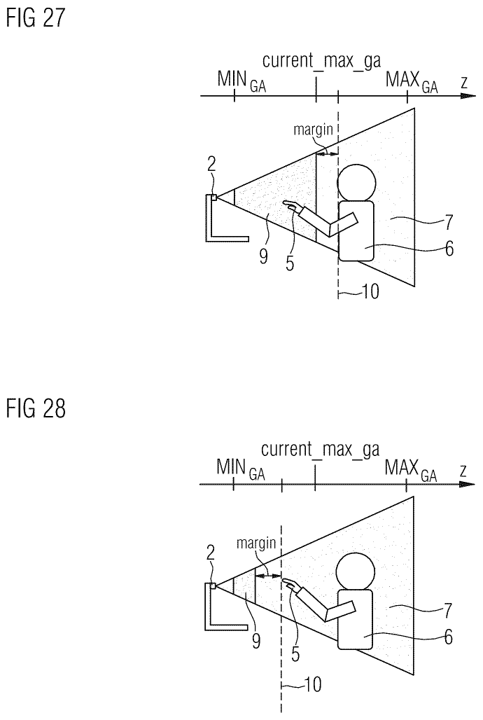

FIG. 27 corresponds to FIG. 24. Subsequently, according to FIG. 28 the object stays at the same position indicated in FIG. 27 for a duration D, wherein the duration D is larger than a predetermined time interval. Thus, in this case the object is not detected since a time frame N+K, while the object was detected for the time frame N+K−1. In this case the hand is now considered as part of the user layer, wherein the gesture area is updated accordingly.

FIG. 29 indicates indices of pixels of a low resolution time of flight sensor 2 with a 4×4 resolution, i.e. having 16 pixels pi. xᵢ represents the x coordinate of the pixel pᵢ and yᵢ represents the y coordinate of the pixel pᵢ. The values of xᵢ and yᵢ can be arbitrary but should be consistent with the actual order of the pixels.

Assuming that all pixels have the same dimensions, each xᵢ and each yᵢ corresponds to a respective grid value, e.g. for

$${x}_{1} = {x}_{5} = {x}_{9} = {x}_{13} = 0.125 ,$$

$${x}_{2} = {x}_{6} = {x}_{10} = {x}_{14} = 0.375 ,$$

$${x}_{3} = {x}_{7} = {x}_{11} = {x}_{15} = 0.625 ,$$

$${x}_{4} = {x}_{8} = {x}_{12} = {x}_{16} = 0.875 , and$$

$${y}_{13} = {y}_{14} = {y}_{15} = {y}_{16} = 0.125 ,$$

$${y}_{9} = {y}_{10} = {y}_{11} = {y}_{12} = 0.375 ,$$

$${y}_{5} = {y}_{6} = {y}_{7} = {y}_{8} = 0.625 ,$$

$${y}_{1} = {y}_{2} = {y}_{3} = {y}_{4} = 0.875 .$$

Such coordinates output a Hand_position_X corresponding to the first position xₒ and a Hand_position_Y corresponding to the second position yₒ, within the field of view, normalized between 0 and 1. Hand_position_Z corresponding to the third position zₒ represents the average weighted distance of the object to the time of flight sensor.

The gesture recognition method steps, according to an exemplary embodiment, in FIG. 30 include initially the provision of the measurement values of the pixels of the low resolution time of flight sensor, being a 4×4 resolution time of flight sensor, for a current time frame for a time t. The object is considered here as the hand. The method steps S14 to S20 are all part of a gesture recognition pipeline, including a background detector module in S15, a hand detector module S17, a hand trajectory extraction module S19 and a gesture classifier module S20.

In method step S14, it is determined if the hand is detected in a previous time frame dependent on previous measurement values. If no, it is determined if there is at least one element, in the background detector module, in the field of view, S15, and the at least one element is identified, S16. If the at least one element is not identified in S16, the pipeline ends.

If the at least one element is identified in S16 or if the hand was detected in S14, it is determined, in the hand detector module, if the hand is detected in the current time frame S17, and consequently if the current time frame represents the end of a gesture S18. If there is no end of the gesture in S18 the pipeline ends.

If there is an end of the gesture, the gesture is forwarded to the hand trajectory extraction module S19 and the gesture classifier module S20.

Exemplarily, inputs for the background detector module are the depth values and the confidence values of each pixel.

Exemplarily, outputs of the background detector module are at least one of an indicator if the at least one element, in particular the depth values of the at least one element, are identified, a depth value for the at least one element for each pixel, a global distance from the at least one element to the time of flight sensor. The indicator is, for example, “valid” or “unknown”.

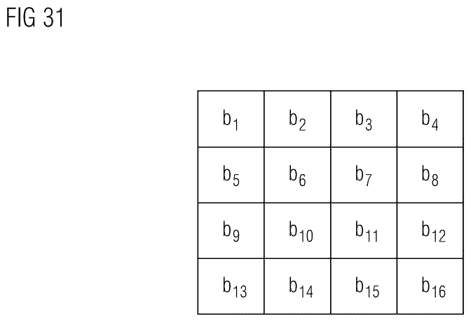

In FIG. 31, the depth values for the at least one element for each pixel b1 to b16 are represented in the 4×4 resolution representation.

Additionally, internal variables for the background detector module are, for example, a circular buffer of size N containing the N last frames including at least one of depth value of the at least one element of N last time frames, a background margin being subtracted from the depth values of the at least one element, a constant maximum depth value of the time of flight sensor, a minimum number of time frames of the at least one of depth values of the at least one element in the circular buffer to consider the indicator as valid.

Exemplarily, N is at least 5, for example 20. Exemplarily, the background margin is, at least 5 cm, for example approximately 12 cm. Exemplarily, constant maximum depth value is at least 3 m or at least 4 m and/or at most 10 m or 6 m, e.g. 5 m.

Exemplarily, inputs for the hand detector module are at least one of the depth values and the confidence values of each pixel, a distance of the user layer for each pixel, wherein the user layer is particularly determined in the background detector module.

Exemplarily, outputs of the hand detector module are at least one of a status if the hand is determined to be between the user layer and the time of flight sensor, a validity of the detection based on the predetermined time interval. The status is, for example, “detected”, “not detected” or “unknown”. The validity is, for example, “valid” or “detected for too long”.

Additionally, internal variables for the hand detector module are, for example, at least one of a preliminary hand detection status being a Boolean function, i.e. being “true” or “false”, a circular buffer comprising the last K preliminary hand detection status, a circular buffer comprising the last K distance frames, a maximum number of time frames in a row where the status is “detected”, a current number of time frames in a row where the where the status is “detected”, a minimum velocity peak characteristic for a minimum depth variation between at least one pixel of the current time frame, and one pixel of the previous time frame, to start detecting the hand, in particular to detect the hand, the minimum predetermined gesture distance characteristic for a lower predetermined limit, the maximum predetermined gesture distance characteristic for an upper predetermined limit, a minimum number of preliminary hand detection status equal to true, in particular in the circular buffer to set the status to “detected”.

Exemplarily, a circular buffer size is characteristic for the at least 3, e.g. 6, last time frames. Exemplarily, the maximum number of time frames in a row are predetermined and constant being at least 40, e.g. 90. 90 time frames in a row correspond, for example, for approximately 3 s, if the time of flight sensor has a frequency of approximately 30 Hz. Exemplarily, the minimum number of preliminary hand detection status equal to true to set the status to detected, is equal to 1.

Exemplarily, inputs for the trajectory extraction module are at least one of the depth values and the confidence values of each pixel for the current time frame, the distance of the user layer for each pixel, wherein the user layer is particularly determined in the background detector module.

Exemplarily, outputs of the trajectory extraction module are at least one of a first position characteristic for a hand position X, a second position characteristic for a hand position Y, a third position characteristic for a hand position Z.

Each outputs of the modules are stored, e.g. in a respective buffer corresponding to a respective module.

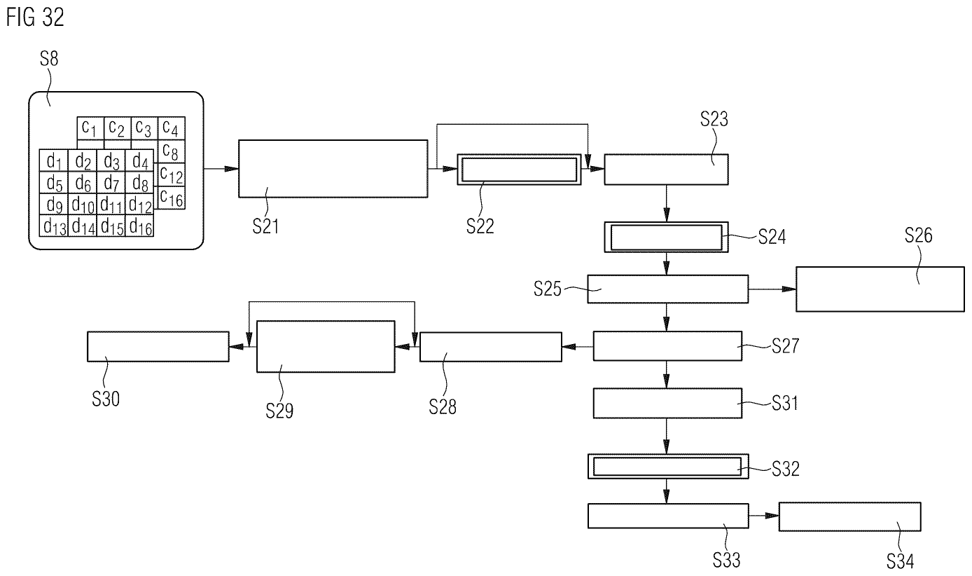

FIG. 32 is a more detailed flow chart of the pipeline of FIG. 30. In method stage S8, measurement values are provided in a current time frame, as described in FIG. 30. In method stage S21, it is determined if the at least one element, in particular the user layer, is identified based on the indicator of the background detector module or if the hand is detected in a previous time frame based on the status of the hand detector module. If the user layer is unknown or if the hand is not detected in the previous time frame, the background detector module variables are updated in S22. If the user layer is known or if the hand is detected in the previous time frame, it is checked if the indicator is valid in S23. If yes, the hand detection module variables are updated in S24.

If the hand is detected for too long based on the validity of the hand detector module in S25, all buffers of all modules are emptied in S26. If the hand is not detected for too long based on the validity of the hand detector module in S25, it is detected if the hand is in the current time frame in S27 in the hand detector module. If yes, it is determined if the hand is in the previous time frame in S28 in the hand detector module.

If the hand is not in the previous time frame in S28, the last minimum number of preliminary hand detection status equal to true of the hand detector module of the last time frames which are added to the background buffer are removed in S29. If the hand is in the previous time frame in S28, the current time frame is added to a gesture buffer.

If the hand is not detected in the current time frame in S27 in the hand detector module, it is determined if the hand was in the previous time frame in S31 in the hand detector module. Subsequently, in S32 the trajectory is calculated from the gesture buffer in the trajectory extraction module. Next, a gesture classification is performed in S33 dependent on the trajectory. Finally, the buffers, in particular the gesture buffer and the hand detection buffer, are emptied in S34.

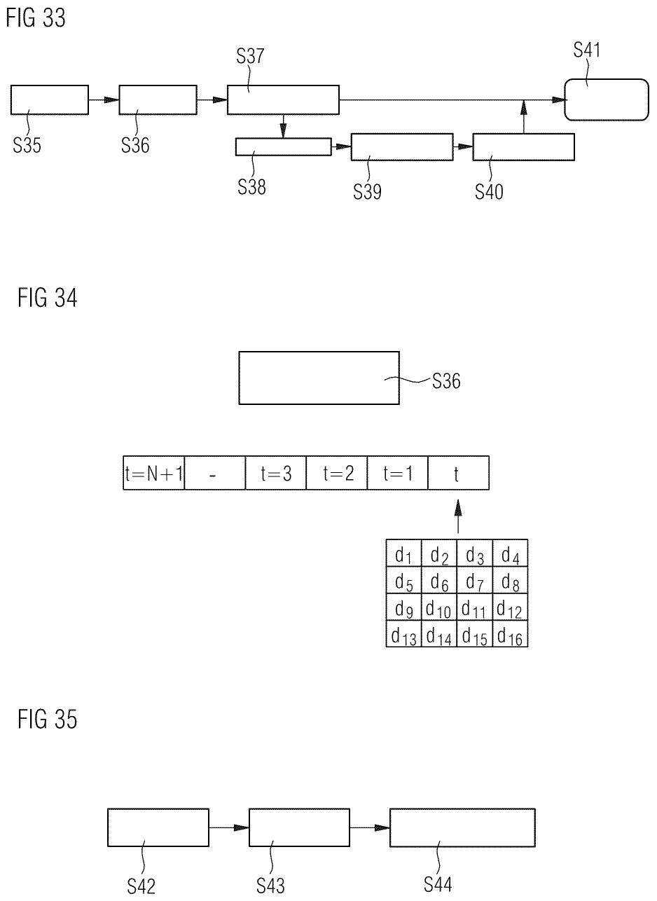

In FIG. 33, a method for updating the background detector module comprises an initialization of the outputs, in particular the background status is set to unknown, of the background detector module in S35. Subsequently, the depth values of the current time frame are appended to the corresponding buffer in S36, which is followed in S37 by determining if the size of the buffer is equal or bigger than a minimum number of time frames, to consider the indicator as valid. If no, the outputs of the background detector module are updated in S41. If yes, the indicator is set to “valid” in S38, the depth value for the at least one element for each pixel is updated in S39 and the global distance from the at least one element to the time of flight sensor is updated in S40.

In FIG. 34, method step S36 is illustrated detailed. The buffer comprises the time frames for the time frame number N−N+1 to t, which is the current time frame to a time t. The depth values dᵢ of every pixel of the current measurement values are inserted in the current time frame t. In particular, the time frame number T is the current time frame, e.g. the last received time frame. For example, the buffer contains the N last time frames, e.g. from T−N+1 to T.

In method step S39, distances bᵢ of the user layer to the time of flight sensor is determined, e.g. computed. In a first step, the depth values of M oldest time frames, except the current time frame, are considered in the buffer. In a second step, the distances bᵢ of each pixel pᵢ is an average of the depth values dᵢ from the M oldest time frames. In particular, the time frames where dᵢ=0 are excluded. In case, dᵢ=0 on all oldest time frames, bᵢ is set to 0. In a third step, for each bᵢ different than 0, a background margin can be subtracted such that bᵢ=max (0, bᵢ−background margin). In a fourth step, if all the bᵢ are determined, a minimum of the bᵢ is determined, minₜ bᵢ, wherein 0 is excluded from the min determination. In particular, if all bᵢ=0, minₜ bᵢ is set to the constant maximum depth value. In a fifth step, all the bᵢ=0 are set to minₜ bᵢ.

In method step S40, the global distance from the at least one element to the time of flight sensor is determined, e.g. computed. In particular, the global distance is set to a minimum value of the depth values for the at least one element for each pixel of the background detector module outputs.

In FIG. 35, a method for updating the hand detector module comprises in S42 to insert the depth values of every pixel of the current measurement values in the circular buffer and to update the preliminary hand detection status in S43. Subsequently, in S44, the status and the validity of the outputs of the hand detector module are updated.

In particular, the update of the preliminary hand detection status in S43 includes, e.g., that the preliminary hand detection status is set to “true”, i.e. the hand is detected in the time frame, if one of the first hand status condition and the second hand status condition are fulfilled.

The first hand status condition is that there is at least one pixel i, for which the two following conditions are fulfilled:

$$\{ \begin{matrix}{d}_{i} < {b}_{i} \\ {d}_{i} < {MAX}_{GA} \\ {d}_{i} > {MIN}_{GA}\end{matrix} ,$$

and
the hand is already detected at least once, in the previous time frames, e.g. by using the circular buffer comprising the last K preliminary hand detection status.

The second hand status condition is that there is at least one pixel i, for which the three following conditions are fulfilled:

$$\{ \begin{matrix}{d}_{i} < {b}_{i} \\ {d}_{i} < {MAX}_{GA} \\ {d}_{i} > {MIN}_{GA}\end{matrix} ,$$

and
the hand is never detected, in the previous time frames, e.g. by using the circular buffer, and
for each pixel j among the pixels, dᵢ(t)−dⱼ(t−1)<−minimum velocity peak. E.g. for the pixels j where dⱼ(t−1)=0, it is considered that dᵢ(t)−dⱼ(t−1)<−minimum velocity peak is fulfilled.

In particular, the update of the status and the validity of the outputs of the hand detector module in S44 includes a first step, wherein the validity is set to “valid” and the status to “not detected”. In a second step, the current preliminary hand detection status is added to the circular buffer of size L. In a third step, a number of time frames for the last L time frames, where the hand is detected is determined, being numₜᵣᵤₑ characteristic for the number of preliminary hand detection status which are “true”. If numₜᵣᵤₑ is equal or bigger than the minimum number of preliminary hand detection status equal to true, the hand is detected and the status is set to “detected”. In a fourth step, the current number of time frames in a row where the status is “detected”, hand detection duration for short, is updated as follows:

If the status is “detected”, the hand detection duration is equal to the hand detection duration+1, else the hand detection duration is 0.

If the hand detection duration is bigger than the maximum number of time frames in a row where the validity is “detected”, in particular, 90 time frames representing approximately 3 s at 30 Hz, the status is set to “not detected”, and the validity is set to “detected for too long”.

Concerning method stage S29 in FIG. 32, the time frames are added in the circular buffer of the background detector module, before identifying if a hand is present in the time frame. In case the hand is detected, it is important to remove the latest time frame for this circular buffer as this circular buffer should contain information only related to the at least one element, i.e. the background, i.e. not the hand. This is that the position of the at least one element per pixel is computed using only the oldest time frames from the buffer.

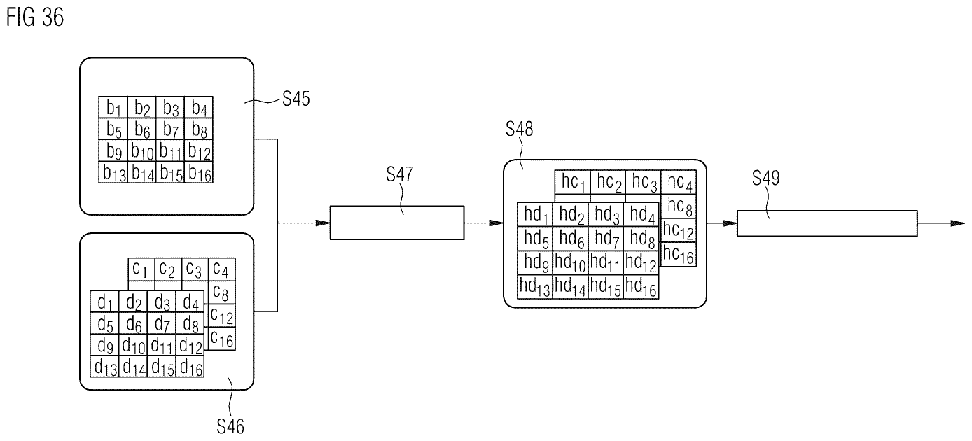

For the calculation of the positions representing the trajectory of the hand from a gesture buffer, the depth values for the at least one element for each pixel according to the FIG. 31 are provide in S45 as well as the depth values and the confidence values are provided in S46, in FIG. 36. This data are pre-processed per time frame in S47, S48. Subsequently, in S49, the positions are calculated with the weighted average function based on the pre-processed data per time frame.

For the pre-processing, the depth values for each pixels are pre-processed. The pre-processed data comprise pre-processed depth values hdᵢ and pre-processed confidence values hcᵢ for each pixel i. In particular, for each pixel i, if at least one of the following conditions is fulfilled:

$$\{ \begin{matrix}{d}_{i} \geq {b}_{i} \\ {d}_{i} > {MAX}_{GA} \\ {d}_{i} < {MIN}_{GA} \\ {c}_{i} = 0\end{matrix} ,$$

then hdᵢ is set to 0.

Otherwise, hdᵢ is set to dᵢ.

In particular, the confidence values cᵢ are pre-processed for each pixel i. For each pixel I, if hdᵢ=0, then hcᵢ is set to 0. Otherwise, hcᵢ is set to cᵢ.

Subsequently, the positions are calculated for each time frame:

$${x}_{0} = \frac{{\sum }_{i = 1}^{n} {x}_{i} \times {hc}_{i}}{{\sum }_{i = 1}^{n} {hc}_{i}} ,$$

$${y}_{0} = \frac{{\sum }_{i = 1}^{n} {y}_{i} \times {hc}_{i}}{{\sum }_{i = 1}^{n} {hc}_{i}} and$$

$${z}_{0} = \frac{{\sum }_{i = 1}^{n} {hd}_{i} \times {hc}_{i}}{{\sum }_{i = 1}^{n} {hc}_{i}} .$$

Exemplarily, for the computer device use case, the depth values and the confidence values are first pre-processed as follows:

Exemplarily, a threshold is applied to the depth values. If the depth value of a pixel is above the threshold, both the depth value and the confidence value for this pixel are set to 0. Further, for example, a correction is applied on the depth values. In particular, the gesture area is not explicit in the implementation, but pre-defined limits, i.e. MIN_{GA}, and MAX_{GA}, are the full field of view, until the threshold. A limit of detection is adjusted dynamically based on previous depth values, comparable to the adjustment of the gesture area.

Exemplarily, to determine the hand, additional conditions have to be fulfilled, when the hand is not previously determined. In particular, the user or the background has to be in the gesture area. The user or the background has to be stable. Both the hand and the user or the background have to be in the frame.

The gesture recognition method steps, according to an exemplary embodiment, in FIG. 37 include initially the provision of the measurement values in S50. The object is considered here as the hand. The method steps include a user detector module in S51, a gesture detector module S52 and a gesture classifier module S53, similar to the modules described in connection with FIG. 30. If the user detector module detects the user in S51, the next step is S52. If the gesture module detects an ongoing gesture in S52, the next step is S53. When the gesture is terminated, the gesture classifier classifies the gesture resulting in an output result in S54. If the user is not detected or if there is no ongoing gesture, the feedback is forwarded to the output result in S54. This is that there is advantageously always feedback about a current status of the method.

According to FIG. 38, the time of flight sensor outputs a depth value corresponding to a radial distance, which corresponds to a system of coordinates that would be (X_{FOV}, Y_{FOV}, r). For the gesture recognition methods, standard orthogonal coordinates (x, y, z) are calculated by transforming the radial distance into a Z coordinate, wherein a Z direction corresponds to an optical axis.

This is that angles α and β indicated in FIG. 38, which correspond respectively to the horizontal and vertical angles between a pixel direction and the optical axis hare calculated as follows:

$${Z}_{i} = r \cdot cos ( {α}_{i} ) \cdot cos ( {β}_{i} ) ,$$

$${α}_{i} = \frac{{x}_{i} - 1.5}{4} \cdot {X}_{FOV} ,$$

$${β}_{i} = \frac{{y}_{i} - 1.5}{4} \cdot {X}_{FOV} .$$

The user detection module in particular determines, i.e. detects, the user, i.e. the user layer dependent on the user. In particular, the user position at pixel i for a time t is determined with a time delay: u_{i,t}=u_{i,t-Δ}_{ₜ}, wherein d_{i,t} is the first distance, i.e. depth value, at pixel i at a time t and Δₜ is between 0 and 1 s, e.g. approximately 0.3 s, being the time delay. The time delay Δₜ is configured to create a gap between the hand position and the user position when the user brings their hand forward. If Δt=0, then the user position is measured at the same distance as the hand, which makes a detection of the hand impossible.

From this per pixel user position determination, a global user position U is calculated for a time t, which corresponds to an estimated single-value position for the global distance between the user and the time of flight sensor:

$${U}_{t} = min ( \{ {u}_{i , t} \vert {u}_{i , t} > 0 \} ) .$$

The global distance is indicated in FIG. 39 as a dashed line.

If all the pixels have a first distance equal to 0, the time of flight sensor does not see anything, and the indicator of the user detector switches to Unknown. In this case, the global user position is arbitrarily set to a maximum value e.g. U=5 m.

If some of the pixels have a first distance equal to 0, i.e. the user position is 0, because no element was found. The user positions for such pixels are adjusted to an estimated value in order to be able to determine, i.e. detect the hand if the enters the field of view from this pixel, e.g. as follows:

$${u}_{i , t} = \vert \begin{matrix}{u}_{i , t} if {u}_{i , t} \neq 0 \\ U \cdot 1.05 otherwise\end{matrix} .$$

Exemplarily, a margin of approximately 5% is applied as a safety margin.

Subsequently to the computation of the user position a validity of the user position is checked, for example. A valid user position is characteristic if the user position is stable in time. If the user position is changing comparatively much, the user is moving a lot in front of the time of flight sensor, e.g., the user is walking, leaning forward and/or is moving the computer device.

To check for user position stability, the global positions determined by the user detector module are stored in a buffer G and the user detector module checks a range of movement in the latest time frames. The range of movement is subsequently compared to a predetermined movement threshold Γ as follows:

$$G = \{ {U}_{t} \} \vert t ∈ [ t ; t - {T}_{s} ] , and$$

$$stable = max ( G ) - min ( G ) < Γ ,$$

wherein
Tₛ is between 0 and 1 s, e.g. approximately 0.3 s, being a time window for the stability check.

If the user position is found to be unstable, the user detector indicator is set to Unknown. This is, exemplarily, that the user has to stand still before being able to do any gesture recognition.

The gesture detector module is characteristic for a determination, i.e. a detection, if the user is currently performing a gesture or not. First, the gesture detector module is configured to identify a presence of the hand in between the user and the time of flight sensor. Depending on the results, the gesture detector module decides whether a gesture is ongoing or not. Further, the gesture detector module is exemplarily configured to sanity check the gesture, in order to estimate if the gesture can be safely analysed or not.

In particular, the gesture detector module comprises the hand detection module, a gesture module comprising for example the hand trajectory extraction module and exemplarily a sanity check.

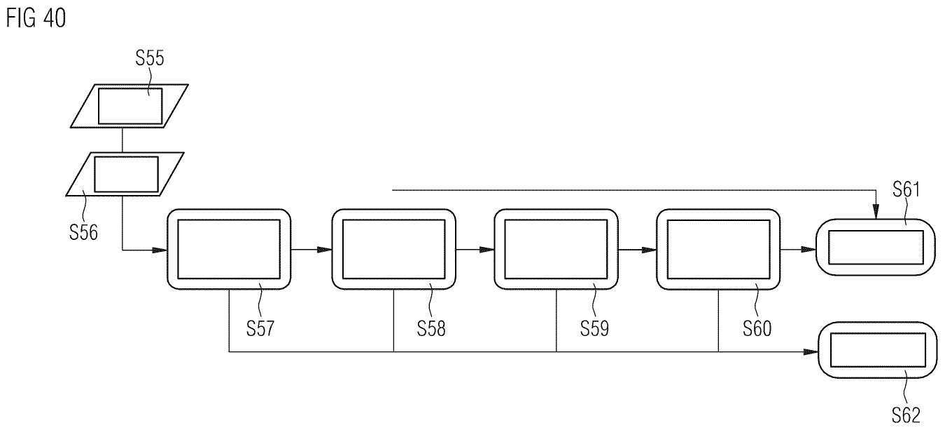

The hand detection module pipeline is shown in FIG. 40, wherein the hand detection module is in particular configured to determine, i.e. detect, whether the user is presenting the hand in between the user and the time of flight sensor. Confusion between the hand and other body parts such as the head, the torso and/or the shoulder, people which are passing by and/or objects such as furniture, are advantageously avoided.

The user position and the measurement values are provided in S55 and S56. Subsequently, in S57, a foreground segmentation is performed. In particular, all the pixels that are in front of the user are isolated, with an arbitrary safe margin. If the isolated set is not empty, the isolated set contains possible candidates for the user's hand. This is, if the hand is between the user and the time of flight sensor, S58 is performed, corresponding to a determination if the gesture is terminated or not. If the hand is not between the user and the time of flight sensor, the hand is not detected, S62. If the gesture is terminated, the hand is detected, S61. If the gesture is not terminated, two checks are subsequently performed in S59 and S60, to eliminate false positives.

If the gesture is detected in S58, the hand is detected in S61.

In S59 a velocity peak is verified, in particular determining if a disruption in the velocity is present. If no, the hand is not detected. If yes, it is verified in S60 if the user is still visible in the time frame.

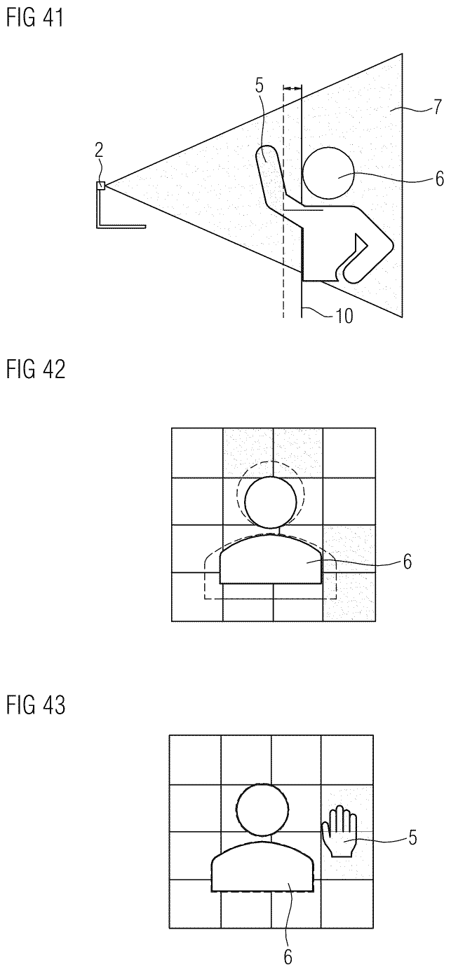

Exemplarily, the foreground segmentation comprises to keep only the pixels that represent the object 5 located between the user 6 and the time of flight sensor 2, according to FIG. 41. Exemplarily, the distance, i.e. depth value, of the user 6 is considered pixel by pixel. To account for movements of the user 6 and the possible lack of precision of the time of flight sensor 2, a margin of error of approximately 12 cm is applied. This is that the pixels are filtered such that only the pixels are kept being those that are characteristic for an object 5 between the time of flight sensor 2 and the position of a user layer 10 of the user 6 minus the margin of error. In particular, S₁ defined as follows, comprises all the possible candidate pixels for the hand:

$${S}_{1} = \{ i ∈ [ 1 ; 16 ] {\vert}_{{d}_{i} < {u}_{i - 12}}^{{d}_{i} \neq 0} .$$

In particular, more filtering, i.e. performing the two checks, is needed to ensure that the elements of S₁ are not false positives.

The first check comprises the verification that a velocity peak is present. Exemplarily, the hand should enter the field of view from a side instead of moving the hand forward from the head or the torso. When the hand enters the field of view at a given pixel position, the hand creates a depth gap with the previous time frame, i.e. a difference in the depth values of the previous time frame and the current time frame, which is equivalent to an object moving with a comparatively high velocity. Even if the hand is moved from the head or the chest of the user, the high velocity can be determined. This is for example shown in FIG. 43, wherein the hand enters the pixels marked, in particular with the comparatively high velocity.

This second check comprises the verification that the set of pixels S₂ that are detected in front of the user are not due to the user moving forward between two time frames:

$${S}_{2} = \{ i ∈ {S}_{1} \vert \frac{{d}_{i} - {d}_{i , t - 1}}{{Δ}_{t}} < - {V}_{min} ,$$

wherein
d_{i,t} is the distance, i.e. depth values, at pixel i at time t, Δₜ a time between two time frames and Vₘᵢₙ a minimum velocity peak, e.g. at least 0.5 m/s, approximately 0.9 m/s.

Exemplarily, the minimum velocity peak can be triggered by the user 6 moving to the side or moving forward, according to FIG. 42, entering the field of view 7 of a new pixel. The position of the user for a previous time frame is marked black and the position of the user for a current time frame is marked with dashed lines. The new pixels, where the user enters, are marked accordingly in FIG. 42.

Considering that the new pixel is pointing towards a wall for a previous time frame, and that the user moves to the side or forward in front of the new pixel in front of the wall for a current time frame. At the new pixel, in just one time frame, the pixel entered the foreground at a very high velocity, being wrongly interpreted as a hand.

To counteract the wrong interpretation, the distances, i.e. depth values, of each candidate pixel are compared with all the other pixels of the previous time frame, and check that there is also a velocity gap, i.e. a difference in velocities of the previous time frame and the current time frame, achieving the set S₃:

$${S}_{3} = \{ i ∈ {S}_{2} \vert ∀ j ∈ [ 1 ; 16 ] , \frac{{d}_{i} - {d}_{i , t - 1}}{{Δ}_{t}} < - {V}_{min} .$$

With the set S₃, most of the false hand detections caused by the user moving forward are filtered out. However, if the user is moving fast or if the user is doing specific body movements such as a shoulder rotation, they still can trigger the detection of a hand. An additional check can be applied to improve performance advantageously further, e.g. by a verification of a visibility of the user.

In particular, in a first time frame of the gesture, when the hand enters the field of view from the side, the hand only covers the foreground partially, and some of the background is visible. In particular, at least one pixel detects the distance, i.e. the depth value, of the user as an output. This is not the case when the user is moving forward leading to an additional filtering described as follows achieving the set S₄:

$${S}_{4} = \{ i ∈ {S}_{3} \vert ∃ j ∈ [ 1 ; 16 ] , \frac{{d}_{i} - {u}_{j}}{{Δ}_{t}} < {V}_{min} .$$

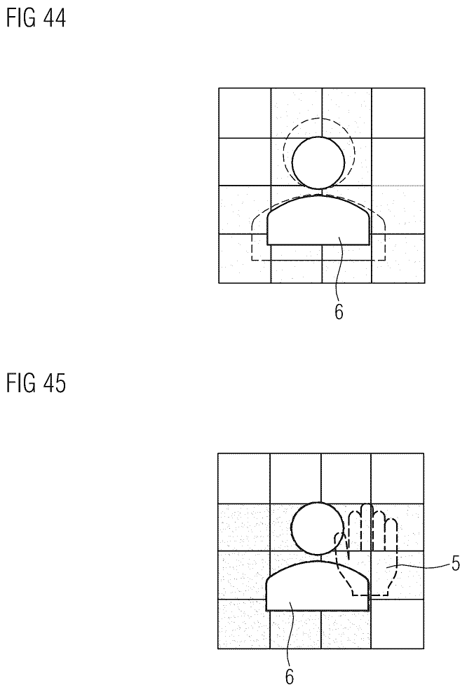

Here, the Vₘᵢₙ value is used, but this time as a maximum velocity, such that a verification can be achieved if in at least one pixel, the user is not moving forward, as visible in FIGS. 44 and 45. In FIG. 44, the user 6 is moving forward, and in FIG. 45, the user 6 is visible while presenting the hand.

The method detects the hand if at least one pixel passes all the previously described checks and verifications, e.g.:

$$det = \vert \begin{matrix}1 if {S}_{4} \neq ∅ \\ 0 otherwise\end{matrix} ,$$

wherein
In particular, the above described checks and verifications are applied to detect the hand for the first time, i.e. when the hand enters the field of view. If the hand is already detected in the previous time frame, the only filter performed is the foreground segmentation.

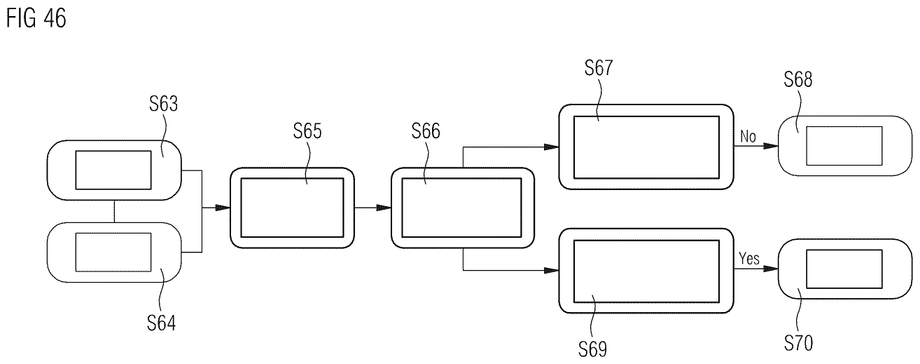

If the hand is detected in a time frame or not, determination method steps follow, whether a gesture is starting, ongoing or ending, or if this hand detection should be discarded, as describes in connection with a gesture detection pipeline in FIG. 46.

In S63 and S64 inputs are provided, wherein in S63 the hand is detected, i.e. determined, and in S64 the hand is not detected, i.e. not determined. Failures can occur, for example, when the measurement values of the time of flight sensor are flickering, exemplarily due to comparatively strong ambient light, or an element placed at edges of the field of view of any pixel. In particular, to avoid triggering a gesture wrongly, a buffer is implemented, recording the presence of the hand in the last N=3 time frames, in S65. In S66 it is determined, if a gesture is ongoing or not. If the gesture is ongoing, it is determined in S67 if there is at least 1 detection of the hand in the buffer. If no, no gesture is ongoing as an output in S68. If the gesture is not ongoing, it is determined in S69 if there are at least 2 detections of the hand in the buffer. If yes, the gesture is ongoing as an output in S70.

Exemplarily, a new gesture is triggered only if at least k=2 of the last N time frames comprise the hand. On the opposite, once the gesture has started, the gesture ends only when no hand is detected in the last N frames.

For example, sanity checks are performed to discard non-gesture events, comprising at least one of a gesture maximum duration check and a not-in-front check.

For the gesture maximum duration check, exemplarily, gestures are defined in a vocabulary, which are smaller than a duration threshold. At an end of a gesture, a length of the last gesture is compared with a duration threshold. The duration threshold is in particular configurable. A default value of the duration threshold is exemplarily set to 3 seconds. In case a duration of a gesture is too long, i.e. larger than the duration threshold, the last detected gesture is discarded and/or classified as “No gesture”.

The not-in-front check comprises to determine if a gesture is performed in front of the sensor or not. If not, the gesture is characteristic for a gesture to far from the time of flight sensor, in particular when the distance of the hand is larger than a distance threshold. This exemplarily causes the hand to cross comparatively few pixels to perform a good analysis of the movement.

At the end of a gesture, a number of pixels where the hand is detected during the last gesture is determined. The number of pixels is subsequently compared to a predetermined number threshold k_{NIF}. If the number of pixels is larger than or equal to the k_{NIF} the gesture is detected as potentially valid. If the number of pixels is smaller than the k_{NIF}, the gesture is discarded and/or classified as “No gesture”, in particular with a discard reason “Not in front of the sensor”.

Exemplarily, if the user stands too far away from the time of flight sensor, in particular when the distance of the user is larger than a further distance threshold d_{NIF}, the pixels extensions, i.e. the corresponding main extension areas, are too big for the hand to cross a plurality of them.

Default values for the not-in-front check are, exemplarily k_{NIF}=10 and d_{NIF}=600 mm.

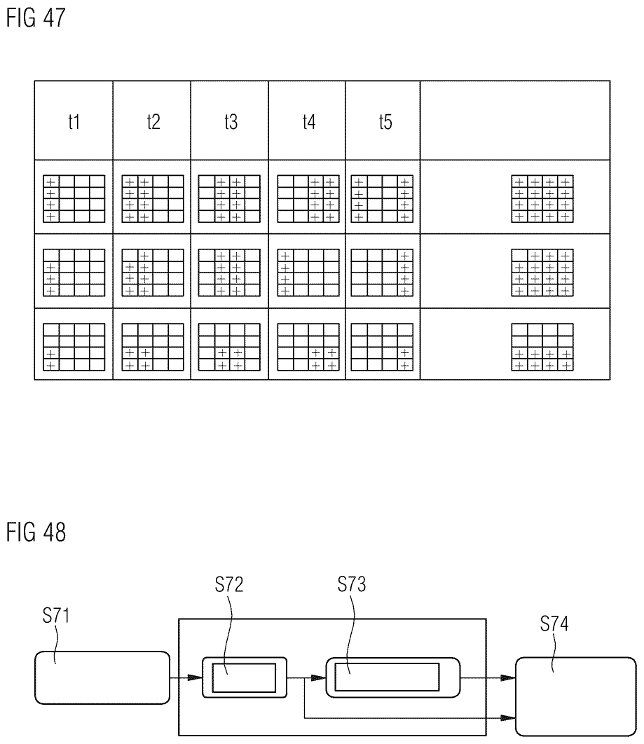

In FIG. 47, a not in front check is exemplarily shown. The rows correspond to different gesture characteristics for different swipe left variations. The first five columns correspond to pixels for subsequent time frames t1 to t5, wherein pixels where the hand is determined are marked with a “+”. In the fifth column, the number of pixels during the gesture where the hand is detected are indicated with the “+”. For the gestures in rows 1 and 2, the gesture is valid as the number of pixels is larger than the k_{NIF}=12. For the gestures in row 3, the gesture is invalid, i.e. not in front of the sensor as the number of pixels is smaller than the k_{NIF}.

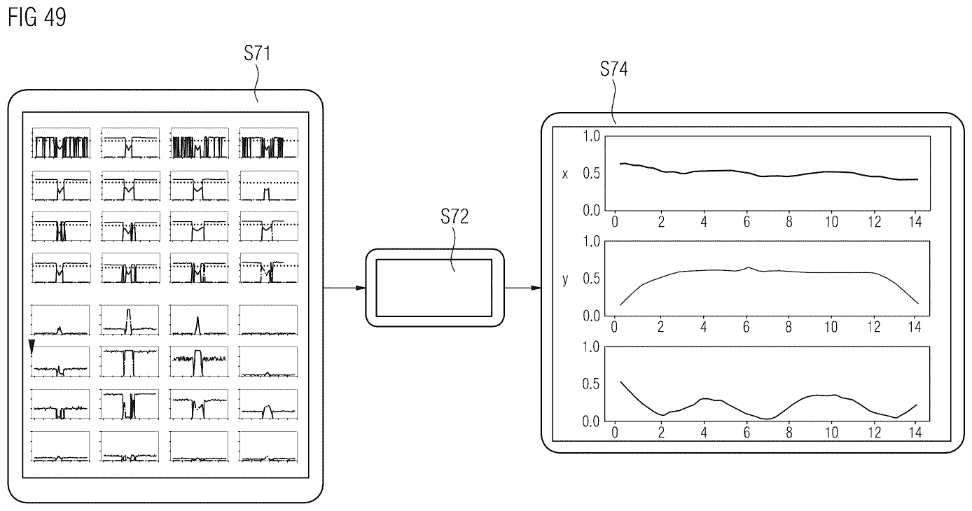

Subsequently to the sanity checks, the hand detector module informs the gesture classifier that the end of a valid gesture is determined. In particular, the hand detector module forwards the corresponding time frames as an input to the gesture classifier, shown in FIGS. 48 and 49, in particular S71. In S72, the trajectory of the hand is extracted dependent on the input. Subsequently, in S73, the trajectory is classified by a neural network. An output of the gesture classifier comprises in S74 at least one of a gesture name, a gesture duration and a gesture amplitude.

The neural network is, for example, of a Long Short-Term Memory Networks, LSTM, type, which is in particular configured and trained to take as an input a temporal series characteristic for the gesture and classify them into pre-defined categories.

Exemplarily, the input to the neural network are not raw data of the time frames, i.e. depth values and confidence values, as indicated in S71. For example, the input in S71, is pre-processed. In particular, in S72 the trajectory of the hand is extracted and the trajectory is used as input for the neural network in S73.

Exemplarily, for computing, i.e. extracting, the trajectory, only the pixels with a depth value being small compared to the position of the user are kept. For the other pixels, the depth values and confidence values are set to 0. This is, in particular:

$$∀ i ∈ [ 1 ; 16 ] , ∀ t ∈ [ 0 ; T ] {\vert}_{{c}_{i , t} = 0 if {d}_{i , t} < U else {c}_{i , t}}^{{d}_{i , t} = 0 if {d}_{i , t} < U else {d}_{i , t}} ,$$

wherein
T is a total number of time frames of the gesture, U the global user position and d and c the measurement values.

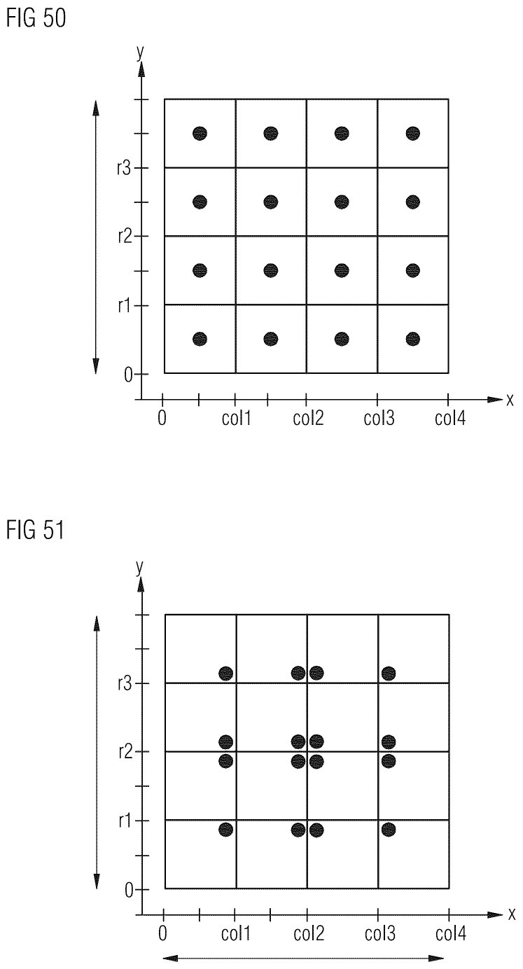

Subsequently, the trajectory is computed by computing the positions xₒ, yₒ and zₒ is accordingly, exemplarily indicated in FIG. 50.

If a sum of all the confidence values is 0, the corresponding time frame is identified as a gap in the time frames of the gesture, for example.

The time of flight sensor typically has a stronger signal-to-noise ratio for electromagnetic radiation that are closest to a centre of the time of flight sensor, such that the confidence values tend to be higher in regions of the pixels pointing to the centre. Thus, typically the calculated positions of each pixel corresponds to a position that is not located at the centre, but on corners as shown in FIG. 51.

For example, if a duration of consecutive gaps in the time frames of the gesture are higher than a maximum duration of gaps, the extraction is marked as failing, and the gesture is not processed by the neural network. An “invalid gesture” status will be issued instead. Exemplarily, the maximum duration of gaps is predefined to be approximately T_{gap}=0.6 s.

Trajectory being calculated, i.e. extracted, is, for example, subsequently reshaped to a fixed length of in particular 30 time frames using an interpolation method. Advantageously, the length of 30 time frames is determined for performance optimization.

For example, the reshaped trajectory is subsequently converted to a numeric scale, such that the trajectory is advantageously easier to handle for the neural network. Further, the converted trajectory is exemplarily normalized, such that the classification is advantageously easier and less dependent on where in the field of view the gesture was performed.

The neural network is, for example, trained with gesture recordings, to recognize the 7 different classes of the gesture vocabulary. The output of the neural network, and thus of the gesture classifier, is a vector λᵢ comprising a likelihood for each of the gestures. A sum of the vector is equal to one, Σλᵢ=1. The gesture of the output is the one corresponding to the highest likelihood, unless the likelihood is lower than 0.5:

$$G = \vert \begin{matrix}i \vert {λ}_{i} = max ( λ ) if max ( λ ) > 0.5 \\ 0 otherwise\end{matrix} ,$$

Exemplarily, a gesture with G=0 corresponds to “no gesture”.

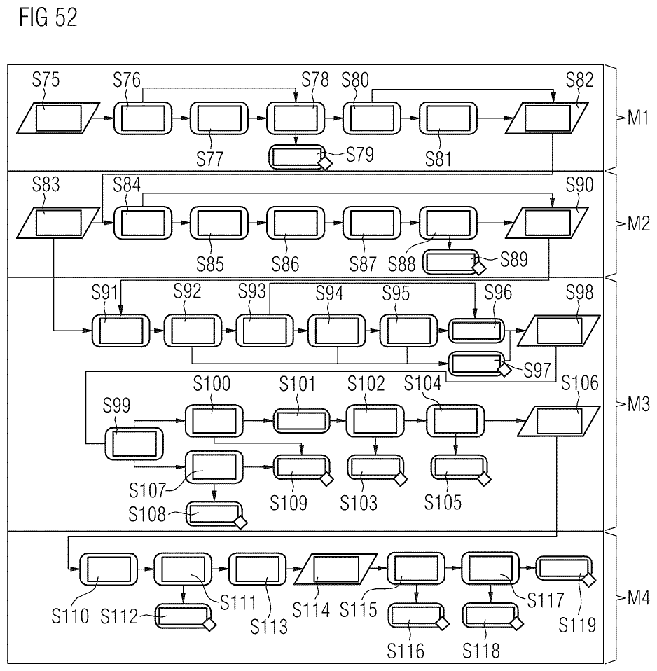

In FIG. 52, a full overview of the gesture recognition pipeline is described. The pipeline comprises a first module M1 corresponding to a configuration optimization module, a second module M2 corresponding to a user detector module, a third module M3 corresponding to a gesture detector module and a fourth module M4 corresponding to a configuration gesture classifier module.

In S75, current configurations of the time of flight sensor are provided as an input. In S76, it is determined if the current configurations are changed with respect to previous configurations. If yes, a reset of the method is performed in S77 followed by determining if the current configuration are corresponding to required configurations in S78. If no, the method is aborted in S79. If yes, it is determined in S80 if a position of a user is known. If yes, optimal configurations are updated in S81 being the required configuration of the time of flight sensor in S82.

In S83, measurement values of the time of flight sensor are provided as an input for a current time frame. In S84, it is determined if a gesture is ongoing. If yes, the position of the user is an output in S90. If no, a position being a first distance is determined in S85 followed by computing a global user position in S86. Null pixels are sanitized in S87 and it is determined if the position of the user is stable in S88. If no, an “invalid user” is indicated in S89. If yes, the position of the user is an output in S90.

Subsequently, dependent on the position of the user in S90 and the measurement values in S83, a foreground segmentation is performed in S91 and it is determined if the foreground is empty in S92. If no, it is determined if the gesture is ongoing in S93. If no, it is determined if there is a velocity peak in S94. If yes, it is determined if the user is still visible in S95. If yes, the hand is determined in S96, i.e. detected, resulting in an output of the hand detection in S98. If the foreground is empty, the hand is not determined in S96, i.e. not detected, resulting in a further output of the hand detection in S98. Both outputs are stored in a buffer.

Subsequently, in S99, it is determined if the gesture is ongoing. If the gesture is ongoing, it is determined if there is at least one detection in the buffer in S100. If no, it is determined that no gesture is ongoing in S101 and followed in S102 by determining if the gesture has a duration of less than 3 s. If no, an “invalid gesture” is indicated in S103. If yes, it is determined if the gesture is in front of the sensor in S104. If no, an “invalid gesture” is indicated in S105. If yes, the gesture is stored in a gesture buffer in S106.

If the gesture is not ongoing in S99 it is determined if there are at least two detections in the buffer in S107. If in S100 and S107 it is determined that there are detections in the buffer, it is determined that the gesture is ongoing in S109. If in S107 it is determined that there are no detections in the buffer, it is determined that the gesture is ongoing in S108.

Subsequently, a trajectory of the hand is determined, i.e. extracted, in S110, dependent on the gesture stored in the gesture buffer. It is determined if there is a gap in the stored gesture in S111. If no, an “invalid gesture” is indicated in S112. If yes, the trajectory is forwarded to a neural network, e.g. LSTM, in S113, and gesture likelihoods are determined in S114. In S115 it is determined if the likelihood corresponds an indicator “no gesture”. If no, an “invalid gesture” is indicated in S116. If yes, it is determined in S117 if a highest confidence is larger than 0.5. If no, an “invalid gesture” is indicated in S118. If yes, the gesture ID from a gesture vocabulary is indicated in S119.

Exemplarily, the method outputs a same results structure for every time frame, even if no gesture is or was detected. This advantageously allows feedback to a client. The result structure comprises, at least some of a timestamp, a position of the user, a global position of the user, an end of a gesture, a status of a gesture detection, a last gesture as well as additional outputs related to the algorithm and sensor configuration.

In connection with FIGS. 53 to 56 a slider control is described. Initially, a hand segmentation is performed. In particular, to isolate pixels representing the hand in a current time frame, the pixel representing a minimal depth value is determined, and all pixels having depth values larger than the minimal depth are removed achieving a first set, in particular, with a margin m. The margin is, for example 5 cm.

$${S}_{1} = \{ i ∈ [ 1 ; 16 ] \vert \begin{matrix}{d}_{i} \neq 0 \\ {d}_{i} < min ( d ) + {m}^{′}\end{matrix}$$

wherein
dᵢ is the depth value at pixel i and m is the margin.

Subsequently the positions of the hand are calculated, wherein he positions are normalized leading to Xᵥ characteristic for xₒ, Yᵥ characteristic for yₒ and Zᵥ characteristic for zₒ. These normalized positions are characteristic for virtual positions of the hand in a virtual grid of arbitrary dimensions (Wᵥ, Hᵥ).

Subsequently it is determined whether the hand is moving or standing still. The hand is determined to be standing still dependent on a region of a predetermined size around an initial position of the hand.

The predetermined size of the region is characteristic for absolute values, e.g. provided in cm. The normalized positions of the hand is, in particular, converted to absolute values.

Exemplarily, absolute dimensions of the virtual grid located at the depth value of the hand and delimited by the field of view are determined:

$${W}_{r} = 2 \cdot {Z}_{h} \cdot tan ( α / 2 ) ,$$

$${H}_{r} = 2 \cdot {Z}_{h} \cdot tan ( β / 2 ) ,$$

wherein
α is a horizontal field of view and β is vertical field of view.

Subsequently, ratios can be applied in order to convert the virtual position of the hand into the real positions:

$${X}_{r} = \frac{{X}_{v} \cdot {W}_{r}}{{W}_{v}} , {Y}_{r} = \frac{{Y}_{v} \cdot {H}_{r}}{{H}_{v}} , {Z}_{r} = {Z}_{v} .$$

The real hand positions P, comprising the Xᵣ, Yᵣ and Zᵣ, is stored in a buffer B={P}_{i∈[0; N]}. The size N of the buffer B is such that the comprised time frames are characteristic for the position of the hand for a last duration D, wherein D is for example 1 s. This is that the hand has to be still, i.e. not moving, for 1 s such that the hand is determined as being still, for example.

To determine that the hand is still during the last duration D, the following check is performed:

$$∀ i ∈ [ 0 ; N ] , ∀ {δ}_{i} < {ε}_{i} , wherein$$

$${δ}_{i} = \vert {P}_{i} - {P}_{o} \vert , and$$

$${ε}_{i} = ( 50 nm , 50 nn , 10 mm ) .$$

The circular slider according to FIG. 53, the hand can be moved circular. Angles from 0° to 360° are mapped to values between 0 and 100. Initially, the position of the hand is determined, shown in FIG. 53 by a dashed hand. The position of the hand is subsequently mapped to an angular value which is converted to a slider value between 0 and 100. Finally, a trigger is set to allow the user to exit the slider mode returning to gesture recognition mode.

When the user moves the hand in a circular movement, for example, the hand is moved across the field of view in order to go to a specific region Pref, e.g. top left corner for right-handed people indicated in FIG. 54. In particular, when moving the hand also a forearm of the user is moved in front of the time of flight sensor, which can have the same depth values as the hand. It is possible that a calculation of the positions and e.g. the trajectory is not possible, in particular because a barycentre will be affected by the forearm.

For example, an additional filter is implemented for the circular hand slider, which comprises in keeping only the pixels with the highest confidence values. In particular, the confidence values have peaks corresponding to the pixels where the hand is present, even when in the corner, thus achieving a first set.

$${S}_{1} = \{ i ∈ [ 1 ; 16 ] {\vert}_{{c}_{i} > {max ( {c}_{i} )}_{i ∈ [ 1 ; 16 ]}}^{{c}_{i} \neq 0} - {c}_{r} ,$$

wherein
Cᵣ is a confidence threshold, e.g. being 100.

For the slider value computation, the position of the hand P is converted into the angle α corresponding to the position of the cursor on a circular form, e.g. by applying the following formulas:

$$α = {tan}^{- 1} ( {δ}_{Y} / {δ}_{X} ) ,$$

$$δ = P - C ,$$

wherein
C is a centre of the circular form, e.g. the position of the hand where the slider mode is activated dependent on the trigger.

A check is performed, considering the last value of the slider's angle, and adjust the angle α, in particular to mimic a real behaviour of a mechanical potentiometer, as follows:
If aₜ<90° and aₜ₋₁>270° then aₜ=360°, and
If aₜ>270° and aₜ₋₁<90° then aₜ=0°.

Thus, jumps in the values corresponding to 0° And 360° are advantageously avoided. Subsequently, the angle is mapped to a slider value v∈[0,100] by:

$$v = \frac{α \cdot 100}{360} .$$

Further, the hand has to be at least 3 cm away from the centre for the output of this slider to be trusted, otherwise a status of the slider is set to “Hand invalid”, as indicated in FIG. 55.

Dependent on the removal of the hand from the slider's operating region, i.e. the region of the predetermined size, the method changes back to the gesture recognition mode. The region of the predetermined size corresponds to a XY plane for a depth value corresponding to the initial position of the hand C.

In particular, a presence of the hand position Pt for a time frame in the region of the predetermined size is determined as follow:

$${b}_{t} = {\vert}_{0 otherwise}^{1 if ( {P}_{t , Z} - {C}_{Z} < 20 cm} ,$$

wherein

Exemplarily, the circular slider mode is only exit when the hand is not determined in comparatively many frames during a last period of time Δₜ. In particular, the slider exits if the following condition is met:

$${\sum }_{t = 0}^{t = {Δ}_{t}} {b}_{t} < B .$$

Exemplarily, Δₜ=50 ms and B=15, at e.g. 30 Hz.

A process for calculating the positions of the hand for a push/pull slider shown in connection with FIG. 56 is the same as for the circular slider mode.

For a determination of a slider value, exemplarily a mapping between a position of the hand P alongside the vertical axis Z and a slider value v∈[0; 100] is performed. Initially, a size and a position of a virtual slider is determined, characteristic for variables (Z₀, L) where Z₀ is a centre of the virtual slider and L is a total length of the virtual slider, e.g. in cm. This is, for example, that the value 0 is located at the depth Z₀+L/2 and the value 100 is located at the depth Z₀−L/2. The mapping corresponds to the following equation:

$$v = 50 \cdot ( 1 + \frac{{Z}_{0} - {P}_{Z}}{0.5 \cdot L} ) .$$

Exemplarily, the length of the virtual slider is arbitrarily set, based on basic ergonomic evaluations, e.g., to L=20 cm. This is that a total amplitude of the movement to control the slider on the full range of values is 20 centimetres. The centre Z₀ is intuitively located at the initial position of the hand (Z₀=C_{Z}), where the user activated the slider mode.

In particular, when the user starts controlling the slider, the initial value is v=50.

For example, the slider value is determined based on a minimal distance dₘᵢₙ, e.g. for forbidding the sliders end to be closer to the time of flight sensor than the minimal distance. This is described by the equation:

$${Z}_{0} = max ( {C}_{Z} , {d}_{min} + \frac{L}{2} ) .$$

The method exits the push/pull slider mode and returns to the gesture recognition mode as soon as the hand is removed from the slider's operating region. In particular, a presence of the hand position Pₜ for a time frame in the region of the predetermined size is determined as follow:

$${b}_{t} = {\vert}_{0 otherwise}^{1 if max ( \vert {P}_{t , X} - {C}_{X} \vert , \vert {P}_{t , Y} - {C}_{Y} \vert ) < 20 cm} .$$

Exemplarily, the push/pull slider mode is only exit similar to the exit of the circular slider mode dependent on the last period of time Δₜ.

This patent application claims the priority of the U.S. patent application No. 63/428,305, the disclosure content of which is hereby incorporated by reference.

The features and exemplary embodiments described in connection with the Figures can be combined with each other according to further exemplary embodiments, even if not all combinations are explicitly described. Furthermore, the exemplary embodiments described in connection with the Figures can alternatively or additionally have further features according to the description in the general part.

The invention is not limited to these exemplary embodiments by the description based on the exemplary embodiments. Rather, the invention encompasses any new feature as well as any combination of features, which in particular includes any combination of features in the patent claims, even if this feature or combination itself is not explicitly stated in the patent claims or exemplary embodiments.

### REFERENCES

1 trajectory
2 low resolution time of flight sensor
3 pixel
4 grid points
5 object
6 user
7 field of view
8 end plane
9 gesture area
10 user layer
11 background
xᵢ first component
yᵢ second component
zᵢ third component
xₒ first position
yₒ second position
zₒ third position
p pixel
t time
d depth value
c confidence value
hd pre-processed depth value
hc pre-processed confidence value
M1 . . . M4 modules
S1 . . . S119 method stages

1. A method for calculating a trajectory of an object with a low resolution time of flight sensor with pixels arranged in lateral directions next to one another, comprising:
providing measurement values of the pixels for different time frames,
determining a user layer dependent on the measurement values,
determining that the object is between the user layer and the time of flight sensor dependent on the measurement values,
calculating for every time frame a position in lateral directions of the object with a weighted average function dependent on the measurement values, wherein
the positions in lateral directions of the object are representative for the trajectory of the object.

2. The method according to claim 1, wherein
the user layer is characteristic for a user or a background, or
the user layer is an end plane of a field of view of the low resolution time of flight sensor.

3. The method according to claim 1, wherein the determination that the object is between the user layer and the time of flight sensor dependent on the measurement values comprises
determining that the object is in a gesture area.

4. The method according to claim 3, wherein a distance range of the gesture area is dynamically adjusted dependent on the measurement values.

5. The method according to claim 1, wherein
a position in vertical direction of the object is calculated for every time frame with the weighted average function dependent on the measurement values, wherein
the positions in vertical direction are representative for the trajectory of the object.

6. The method according to claim 1, wherein each measurement value comprises for each pixel and each time frame a depth value in vertical direction and a confidence value.

7. The method according to claim 1, wherein the user layer is determined dependent on the measurement values for different time frames, if a change in the measurement values is smaller than a predetermined threshold.

8. The method according to claim 1, wherein the object is determined to be between the user layer and the time of flight sensor dependent on the measurement values for subsequent time frames.

9. The method according to claim 6, wherein the object is determined if a first condition and a second condition are fulfilled,
the first condition is fulfilled when
the depth value of a current time frame of at least one pixel is smaller than any of the depth value of a previous time frame of every pixel, or
the depth value of a current time frame of at least one pixel is smaller than the depth value of a previous time frame of the same pixel or a different pixel, and
the second condition is fulfilled when
the depth value of the current time frame of the at least one pixel is within the gesture area.

10. The method according to claim 1, wherein
when the object is determined to be between the user layer and the time of flight sensor,
an object layer is determined,
the object layer extends in vertical direction from a minimal depth value in direction to the user layer.

11. The method according to claim 1, wherein
when the trajectory is calculated, only the measurement values of the object layer are considered.

12. The method according to claim 6, wherein
each pixel has a predetermined grid value being characteristic to a position in lateral directions of the respective pixel,
each grid value comprises a first component xᵢ and a second component yᵢ, where i=1 . . . n, where n is the number of pixels, and
the trajectory in lateral directions is calculated exclusively dependent on the confidence values and the grid values.

13. The method according to claim 12, wherein
the position in lateral directions of the object comprises a first position xₒ and a second position yₒ, wherein
the first position xₒ is calculated for each time frame as follows:
$${x}_{o} = \frac{{\sum }_{i = 1}^{n} {x}_{i} \times {c}_{i}}{{\sum }_{i = 1}^{n} {c}_{i}} ,$$
and
the second position yₒ is calculated for each time frame as follows:
$${y}_{0} = \frac{{\sum }_{i = 1}^{n} {y}_{i} \times {c}_{i}}{{\sum }_{i = 1}^{n} {c}_{i}} .$$

14. The method according to claim 6, wherein
each pixel has a third component zᵢ being characteristic for the depth value of the respective pixel, where i=1 . . . n, where n is the number of pixels,
the position in vertical direction of the object comprises a third position zₒ, wherein
the third position zₒ is calculated for each time frame as follows:
$${z}_{0} = \frac{{\sum }_{i = 1}^{n} {z}_{i} \times {c}_{i}}{{\sum }_{i = 1}^{n} {c}_{i}} .$$

15. The method according to claim 1, wherein an end point of the trajectory of the object is displayed on a screen.

16. Method A method for gesture recognition, wherein the trajectory of the object, which is calculated according to claim 1, is provided for a machine learning model, in particular an artificial intelligence.

17. A system for calculating a trajectory of an object with a low resolution time of flight sensor with pixels arranged in lateral directions next to one another, configured to perform the method according to claim 1.

18. The system according to claim 17, wherein the low resolution sensor has at most 8×8 pixels.

19. A computer program comprising instructions which, when the computer program is executed by a computer, cause the computer program to perform the method according to claim 1.

20. A computer-readable storage medium on which the computer program of claim 19 is stored.
